(19) United States
(12) Patent Application Publication
(10) Pub. No.: US 2026/0089181 A1
(43) Pub. Date: Mar. 26, 2026

(54) CYBERSECURITY PLATFORM INCLUDING TRAFFIC SENSOR

(71) Applicant: iOT365, Inc., Netanya (IL)

(72) Inventor: Alexander TARTAKOVSKY, Netanya (IL)

(21) Appl. No.: 19/395,838

(22) Filed: Nov. 20, 2025

Related U.S. Application Data
(63) Continuation-in-part of application No. PCT/US2024/033946.
(60) Provisional application No. 63/472,626, filed on Jun. 13, 2023.
(60) Provisional application No. 63/921,119, filed on Nov. 19, 2025.

(51) Int. Cl. H04L 9/40; H04L 41/16

(52) U.S. Cl. CPC H04L 63/1425; H04L 41/16; H04L 63/1466

(57) ABSTRACT

Described herein, the All-In-One cybersecurity platform combines advanced hardware components, intelligent analysis techniques, agentless SIEM, and AI-generated playbooks to provide organizations with comprehensive protection against cyber threats while ensuring compliance with industry standards and regulations. As described herein, the platform advances in fast deployment, unique aggregation, and sorting of relevant data powered by ML and AI layers, making the required mitigation easy with AI-generated playbooks. This platform is game changer for big organizations where detection speed, distribution and incident Response are critical factors.

### CROSS-REFERENCE TO RELATED APPLICATIONS

This application is a Continuation-in-part of PCT Application Ser. No. PCT/US24/33916 filed Jun. 13, 2024, which claims priority to and benefit of U.S. provisional patent application Ser. No. 63/472,626 filed Jun. 13, 2023; this applicant also claims benefit and priority to US provisional patent application Ser. No. 63/921,119 filed Nov. 19, 2025. The disclosures of all of the above patent applications are hereby incorporated herein by reference.

### BACKGROUND

### Technical Field

The disclosure relates to cybersecurity and more specifically to universal intelligent devices, SIEM and AI-generated playbooks.

### Related Art

In today's hyper-connected digital landscape, cybersecurity threats have become more sophisticated and pervasive, posing significant challenges to organizations of all sizes and across all industries. Traditional cybersecurity solutions often rely on agent-based approaches, which can be resource-intensive, complex to manage, and incompatible with diverse IT architectures. Moreover, the increasing complexity of cyber threats demands proactive and adaptive security measures that can swiftly detect, respond to, and mitigate emerging risks.

Existing cybersecurity systems typically employ an “agent” on protected devices. Such an agent can include software executing on an operating system of the protected devices and configured to monitor status of and activity on the protected devices. Not all networked devices are capable of executing an agent.

### SUMMARY

To address various challenges of the prior art, we present a novel cybersecurity system that provides comprehensive protection across heterogeneous OT/IT environments in which some devices are agentless. In various embodiments, the disclosed system leverages a traffic sensor capable of seamlessly integrating with diverse infrastructure architectures, including cloud, on-premises, hybrid, OT (Operations Technology), and IT (Internet of Things) deployments. The traffic sensor is a physical device configured to connect to a network switch and collect traffic passing through the switch. The traffic sensor enables the implementation of cybersecurity in systems that include devices that cannot easily support an agent.

Data collected by the traffic sensor, and optional agents, may be subject to behavioral analysis, anomaly detection, and/or machine learning systems to identify and thwart malicious activities in real time. Unlike conventional signature-based approaches, the cybersecurity platform provides proactive threat detection capabilities. For example, data collected in both an agentless manner and using a client-side agent can be normalized and processed using AI-generated playbooks. These playbooks leverage machine learning models trained on vast datasets of historical security incidents to automate response actions, streamline incident resolution workflows, and enhance overall operational efficiency.

Together the various cybersecurity systems and methods discussed herein may be embodied in a SIEM (Security Information and Event Management).

Various embodiments of the invention includes: Deployment of an isolated AI engine that correlates perfectly with the detected threat's database, enabling the demonstration of the AI-Generated playbooks according to the required standard.

A system comprising four processing layers of an SIEM platform and the four processing layers, comprising: a feed detection layer, a machine learning layer, an SIEM correlation layer, and an AI layer. The system wherein the feed detection layer continuously monitors network traffic and compares it against known threat indicators from various feeds to proactively identify and alert threats based on known patterns and signatures. The system wherein the feed detection layer uses signature-based IP, hash, and URL databases, as well as custom IDS.

The machine learning layer optionally uses pattern recognition, anomaly detection, and continuous learning to analyze network behavior, device interactions, and data flows to identify deviations from normal patterns. The machine learning layer by continuously learning from the environment, is optionally configured to detect previously unseen or unknown threats, including zero-day vulnerabilities. The SIEM correlation layer optionally performs real-time correlation of events and alerts generated from collected data of the SIEM platform. The correlation optionally includes application of a taxonomy model for event correlation, combining data from multiple sources to identify relationships and potential security incidents. The AI layer optionally comprises automated decision-making.

The AI layer optionally comprises contextual understanding and predictive capabilities. The machine learning layer or the AI layer optionally uses deep learning. The machine learning layer or the AI layer optionally uses an artificial neural network (ANN).

Various embodiments of the invention include a method, comprising supporting a feed detection layer via a SIEM platform; supporting a machine learning layer via the platform; supporting a SIEM correlation layer via the platform; and supporting an AI layer via the platform. The feed detection layer optionally continuously monitors network traffic and compares it against known threat indicators from various feeds to proactively identify and alert threats based on known patterns and signatures. The feed detection layer optionally uses signature-based IP, hash, and URL databases, as well as custom IDS. The machine learning layer optionally uses pattern recognition, anomaly detection, and continuous learning to analyze network behavior, device interactions, and data flows to identify deviations from normal patterns. The machine learning layer by continuously learning from the environment, is optionally configured to detect previously unseen or unknown threats, including 6 zero-day vulnerabilities. The SIEM correlation layer optionally performs real-time correlation of events and alerts generated from collected data of the SIEM platform. The correlation optionally includes application of a taxonomy model for event correlation, combining data from multiple sources to identify relationships and potential security incidents. The AI layer optionally comprises automated decision-making, contextual understanding and predictive capabilities.

Various embodiments of the invention include a method comprising: supporting a feed detection layer via a SIEM platform; supporting a machine learning layer via the platform; supporting an SIEM correlation layer via the platform and supporting an AI layer via the platform, wherein the machine learning layer or the AI layer optionally uses deep learning, and wherein the machine learning layer or the AI layer uses an artificial neural network (ANN).

Various embodiments of the invention include a security information and event management system comprising: an input configured to receive and store logs of traffic sensor data from a plurality of sources, the sources including at least one agentless source and including mirrored network traffic, the traffic sensor data being communicated using a plurality of protocols; an optional input configured to receive events from a security agent; normalization logic configured to normalize the traffic sensor data communicated using the plurality of protocols to a normalized (generic and protocol independent) representation; correlation logic configured to produce correlation data based on correlation between the normalized representation of the traffic sensor data and a plurality of attack methodologies; and a machine learning system trained using the correlation data, and configured to detect security events based on the normalized traffic sensor data. Optionally, the normalization logic and/or correlation logic are disposed on a hardware device configured to be connected to a network switch, wherein the hardware device is optionally configured to communicate to a security server using an encrypted VPN. Optionally, the normalization logic is disposed in a virtual device configured to physical network adapter connected to a virtual machine server, wherein the virtual device is optionally configured to communicate to a security server using an encrypted VPN.

Optionally, further comprising AI training logic configured to train the machine learning system using the correlation data. Optionally, further comprising a plurality of physical condition sensors. 6. The system of any of the preceding claims, wherein the physical condition sensors include a temperature sensor, a pressure sensor, a camera, and/or an access control device. Optionally, the plurality of attack methodologies include at least 2 (or three or four) or more of MITRE Attack ICS methodology. NIS2, NIST, and IEC 62443 methodologies. Optionally, the normalization logic is disposed at least in part in a traffic sensor that generates the traffic sensor data. Optionally, the traffic sensor data include data communicated to or from a programmable logic controller, OT, human machine interface, SCADA, or other IoT device, e.g., data written to or read from these devices. Optionally, wherein the traffic sensor data is generated by a single traffic sensor connected to a plurality of physical network switches, the single traffic sensor including multiple Ethernet monitoring ports.

### BRIEF DESCRIPTION OF THE DRAWINGS

FIG. 1 illustrates an overview of the architecture and connectivity of an example of a SIEM (Security Information and Event Management) system, according to various embodiments.

FIG. 2 illustrates a network topology diagram in which physical intelligent sensors are connected to managed switches by mirroring ports in three different sites, according to various embodiments. The sensors gather relevant network data, sort it according to the methods discussed herein, and upload it to the main VM server in the cloud on-premises.

FIG. 3 illustrates a network topology diagram in which virtual Intelligent sensors are connected to managed switches by mirroring ports in three sites, according to various embodiments. The sensors gather relevant network data, sort it according to the methods discussed herein, and upload it to the primary VM server in the cloud on-premises.

FIG. 4 illustrates the deployment of Virtual Intelligent Sensors in a Virtual Machine, according to various embodiments.

FIG. 5 illustrates intelligent sensor connection method and functionality, according to various embodiment.

FIG. 6 illustrates an intelligent sensor software architecture, according to various embodiments.

FIG. 7 illustrates an example collection service of the SIEM platform in accordance with various embodiments.

FIG. 8 illustrates an example of an intrusion detection system (IDS) service of the SIEM platform, in accordance with various embodiments.

FIG. 9 illustrates an example of the normalization process of the SIEM platform in accordance with various embodiments.

FIG. 10 illustrates an example correlation service of the SIEM platform in accordance with various embodiments.

FIG. 11 illustrates an example transmission service of the SIEM platform in accordance with embodiments.

FIG. 12 illustrates an example command and control center of the SIEM platform in accordance with various embodiments.

FIG. 13 illustrates an example web service component of the SIEM platform in accordance with various embodiments.

FIG. 14 illustrates AI-generated Playbooks workflow according to NIS2, NIST, or IEC-62443 Standard, in accordance with various embodiments.

FIG. 15 illustrates features of a Multi-Layer Intrusion Detection System (IDS), according to various embodiments.

### DETAILED DESCRIPTION

Described herein are systems and methods using advances in cybersecurity technologies and architecture to overcome technical problems associated with implementing security in a very large-scale computer network or environment. In some embodiments such systems and platforms include an agentless multi-layer Internet of Things (IOT), or operations technology (OT) system dedicated to threat detection. The SIEM platform and other embodiments described herein can be implemented to operate effectively with a very large-scale computer network. The SIEM is multi-layered in that it can be used to provide multiple layers of security to both agentless and/or agent assisted devices.

The rapid growth of IoT, industrial control systems (ICS), and OT networks has introduced unique security challenges. Known SIEM solutions designed for networks struggle to effectively monitor and secure environments having IoT devices, ICS, and OT devices on which executing a security agent is difficult if not impossible. The known SIEM solutions may lack specialized functionalities and require agents or active connections, which are often impractical for networks having IoT devices, ICS, and OT devices. For example, it may be difficult to install and update a security agent on an IoT device.

To address these limitations, some embodiments of the SIEM platform disclosed herein employ a passive agentless architecture and provide tailored threat detection and incident response capabilities for networks having IoT devices, ICS, and OT devices.

The SIEM platform is a novel and technical solution designed to provide comprehensive threat detection and incident management for such networks. In some embodiments, the SIEM platform includes distributed design with nearly unlimited event per second (EPS) scalability; and agentless operation with a focus on networks having the aforesaid types of devices. For example, in some embodiments, the platform includes a “MITRE Attack ICS” methodology. In some embodiments, the platform includes a multi-layer defense system empowered by machine learning (ML) and/or artificial intelligence (AI). Various embodiments may include, 3, 4 5, 6 or more such security layers. In some embodiments, the SIEM platform includes a simplified taxonomy including taxonomy-based event correlation. Other attach methodologies supported can include any combination of MITRE, NIS2, NIST and IEC 62443.

The SEIM platform of the invention typically includes two principal components. First, a Universal Intelligent Sensor (UIS), also referred to herein as a traffic sensor, configured to be attached to a network switch and detect network traffic passing through the network switch, and second, an Intrusion Detection System (IDS). The Intrusion Detection System is configured to process data collected by the UIS is a sophisticated hardware component designed to monitor network traffic with high accuracy and efficiency. It is compatible with various network environments and can be seamlessly integrated into existing infrastructure. The UIS is configured to be connected to the mirroring port of a managed switch, allowing it to passively monitor all network traffic without 9 disrupting normal operations of the switch. This integration ensures comprehensive visibility into network activities. Notably, the UIS is configured to monitor communications to and from agentless devices within the protected network, e.g., on devices on which support of a security agent is impossible or impracticable. The IDS module utilizes the data captured by the UIS to detect anomalous behavior and potential security breaches within the network. It employs a combination of signature-based detection, anomaly detection, and machine learning systems to identify threats. Such detection systems may employ off-the-shelf protocols and/or protocols unique to the disclosed system. Data collected by the UIS is normalized, aggregated and sorted by the IDS. The SIEM platform is configured to collect logs and events from various sources, including the IDS module, network devices, security agents, and/or applications, and correlates them to identify patterns indicative of security incidents.

The SIEM (Security Information and Event Management) platform may be configured to provide security to a system including a wide range of devices including servers, clients, virtual devices, and/or a computer network (e.g., LAN/WAN). The SIEM may be disposed one or more traffic sensors and a remote server in communication with the protected systems and devices. For example, a protected system can include a LAN/WAN network(s) including a local area network (LAN) such as a private computer network that connects computers in small physical areas, a wide area network (WAN) to connect computers located in different geographical locations, and/or a metropolitan area network (MAN)—also known as a middle area network—to connect computers in a geographic area larger than that covered by a large LAN but smaller than the area covered by a WAN.

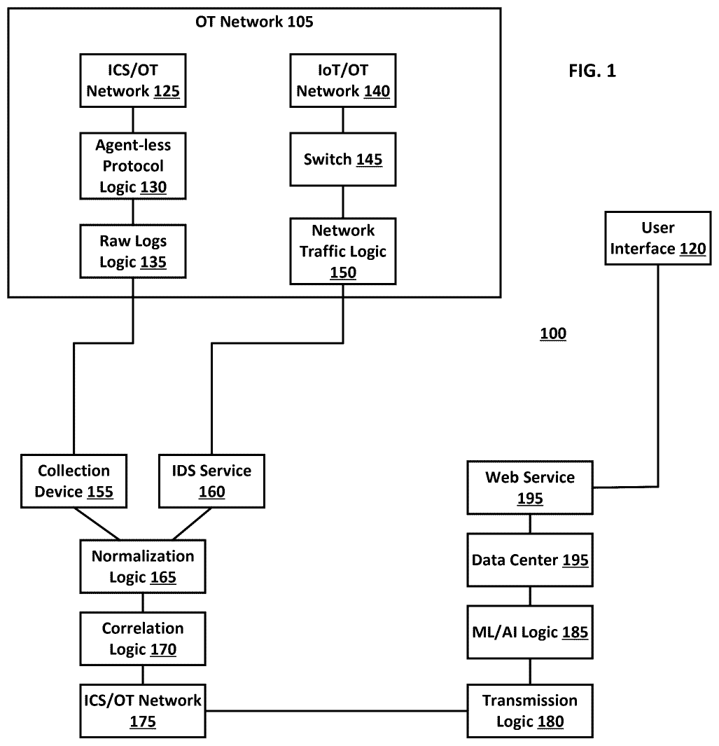

FIG. 1 illustrates an overview of the architecture and connectivity of an example of a SIEM (Security Information and Event Management) system 100, according to various embodiments. FIG. 1 also illustrates how the different services connect and interact with each other to ensure the efficient operation of the SIEM platform. FIG. 1 shows the flow of data and information between the sources from a network having IoT, ICS, or OT devices.

An agentless IoT- or OT-dedicated threat detection SIEM platform 100 (also referred to herein as a cybersecurity platform) includes or is a part of a system configured to ensure security of IoT and/or OT devices. The SIEM platform 100 can provide a modular architecture for the system. In some embodiments, the SIEM platform includes an agentless multi-layer IoT or OT dedicated threat detection system, which also includes or is a part of a system configured to operate with IoT or OT devices. The multi-layer SIEM platform can provide a modular architecture for the corresponding system as well.

In some embodiments, the SIEM platform 100 includes four, five, six or more primary security (threat detection) layers in its architecture. SIEM platform 100 can include a collection module (e.g., including Raw Logs Collection Logic 135, Collection Device 155, and/or IDS Service 160), a detection module (e.g., including IDS Service 160, Normalization Logic 165, and/or Correlation Logic 170), a normalization logic 165, a SIEM correlation logic 170, and/or a machine learning/AI Logic 185.

The collection module is configured to receive raw data from connected sources (such as IoT or OT devices) and filter the data from the connected sources.

The detection module is configured to find security threats according to a unique architecture of the SIEM platform. Also, the detection module is optionally configured to find security threats according to connected open-source or proprietary databases that can be populated by threat data feeds.

The normalization module is configured to retrieve and identify IoT or OT events from the raw data provided by the connected sources. In some embodiments, normalization module is configured to generate a taxonomy according to the category and classification of the identified events. In some embodiments, the taxonomy includes a simplified taxonomy using only relevant fields from IoT- or OT-filtered events. For example, Normalization Logic 165 may be configured to receive traffic data communicated using a variety of different protocols and interpret that data according to each respective protocol, and to generate a normalized (protocol independent) representation of the data.

In a specific example, normalization logic 165 may be configured to receive data from collection device 155, the data representing network traffic communicated using MDNS, NBNS, LLMNR, service_tap, and/or SSDP protocols and to output a generic (normalized) interpretation of the network traffic. Examples of the generic interpretation may include “SSH connection detected” or “DHCP request detected.”

Normalization logic 165 may also be configured to normalize data generate by different agents disposed on the protected network, in various embodiments.

The SIEM correlation module 100 is configured to analyze and correlate events identified within the normalized traffic to determine meaningful patterns, relationships, and potential security threats. The potential threats may need to be apparent when looking at individual events, using the simplified taxonomy.

The machine learning module, e.g., ML/AI Logic 185, is configured to analyze and track traffic corresponding to the connected sources. Also, the machine learning module can be configured to integrate a zero-trust framework with a machine learning system. The machine learning module can include artificial intelligence (AI) that can learn the existing IoT or OT event's behavior, find anomalies, and forecast future AI-initiated cyber-attacks as well as remove false positive cyber threats detection. The AI can be implemented, at least in part, using deep learning, one or more artificial neural networks (ANNs), signal processing techniques, or some combination thereof.

In some embodiments of the SIEM platform 100, the platform includes a fully isolated agentless IoT or OT event collection without changing the hardware setting or existing network topology of an existing system and without connecting to the production network. This can allow for flexible integration with an existing security orchestration, automation and response (SOAR) or SIEM platform of a customer or user of the SIEM platform. In some examples, simplified correlation rules enable fast and short integration and exploitation processes minimizing the need and use of technical resources. In some embodiments of the SIEM platform, the platform includes a dashboard having graphs with zoom-in capabilities by pressing on a graph corresponding to one of the connected sources (such as graphs corresponding to connected IoT or OT devices. In such examples, the graphs can be labeled according to given names of the connected sources. In some embodiments of the SIEM platform, the platform includes transparency and log history of raw IoT or OT data, visibility of detected threats, the IoT or OT devices under attack, integration with CIS (Center for Internet Security) controls or the MITRE ATT&CK framework, or any combination thereof. Also, the SIEM platform can support cloud computing, hybrid computing networks, and on-premises models. And the SIEM platform can support almost unlimited scalability exceeding one million events per second.

Between the elements illustrated in FIG. 1, the data flow starts with the sources from an ICS/OT network 125 having ICS and OT devices as well as an IoT/OT Network 140 having IoT and OT devices. These sources generate raw logs collected and stored by Raw Logs Logic 135 and mirrored network traffic logic 150 that are to be collected for further analysis by the platform. A Collection Device 155, e.g., traffic sensor, which is part of the platform, collects the raw logs using various protocols such as Syslog, Windows Event Collector, OPC UA. This service ensures the reliable retrieval of data from the sources. The IDS Service 160 captures and analyzes raw network traffic using different feeds and rules. ICS/OT Network 125 can include, for example, SCADA (Workstations, Servers, etc.); Controllers (PLC, RTU) and Network Devices (Switch, Firewall, etc.). IoT/OT Network 140 can include, for example, includes physical condition Sensors (Temperature, Pressure, current, etc.); Embedded Systems (Robots, Analyzers, Programmable Logic Controllers, etc.) and Security Devices (IP Cameras, Access control systems, etc.)

An example novel feature of the SIEM platform is its agentless operation, specifically designed to cater to the unique requirements of IoT, ICS, and OT networks. This agentless approach eliminates the need for intrusive software installations on critical devices, ensuring minimal disruption to the network infrastructure. The SIEM system and platform can be used with the MITRE Attack ICS methodology, providing comprehensive coverage and threat visibility for IoT, ICS, and OT environments. By following the MITRE Attack ICS methodology, the SIEM platform uses its advanced capabilities to proactively detect and mitigate cyber threats that target critical infrastructure, offering enhanced security and peace of mind to organizations relying on IoT, ICS, and OT networks.

The IoT365 IDS+SIEM platform is designed to detect cyber-attacks, particularly those targeting Industrial Control Systems (ICS), by leveraging the MITRE ATT&CK methodology. Here's how it operates to identify discovery cyber-attacks within the ICS environment:

### 1. Asset Identification and Baseline Establishment

Device Profiling: IoT365 IDS+SIEM starts by identifying and profiling all devices within the ICS environment. It establishes a baseline of normal behavior for these devices, including communication patterns, protocols used, and typical command sequences.

Network Mapping: The platform maps out the network topology, understanding the connections between different ICS components and identifying critical assets.

### 2. Behavioral Analysis and Anomaly Detection

Continuous Monitoring: The platform continuously monitors network traffic and device behaviors in real-time. It looks for deviations from the established baseline, which could indicate an attempt to discover network and system information.

Signature and Rule-Based Detection: Using predefined rules and signatures derived from known attack vectors and techniques, the platform can identify specific actions associated with discovery attacks, such as network scanning, service enumeration, and file system exploration.

### 3. Application of MITRE ATT&CK for ICS Framework

Technique Identification: The platform is integrated with the MITRE ATT&CK for ICS framework, which provides a comprehensive matrix of tactics, techniques, and procedures (TTPs) used by adversaries. This helps in correlating observed activities with known discovery techniques such as:

Network Service Scanning (T1046): Detects scanning activities aimed at discovering open ports and services.

Remote System Discovery (T1018): Identifies attempts to gather information about remote systems and their configurations.

File and Directory Discovery (T1083): Monitors for adversaries searching for files and directories on a local or remote system.

Network Sniffing (T1040): Detects passive listening on the network to capture information.

### 4. Correlation and Contextual Analysis

Event Correlation: IoT365 IDS+SIEM correlates events across different layers and devices to identify patterns indicative of discovery attacks. For instance, an unusual increase in traffic between PLCs and HMIs might suggest unauthorized probing.

Contextual Awareness: The platform contextualizes the detected activities with historical data and threat intelligence feeds to understand the broader attack scenario. This includes recognizing if the discovery is part of a multi-stage attack.

### 5. Alerting and Response

Real-Time Alerts: When suspicious activities that match discovery techniques are detected, the platform generates real-time alerts. These alerts are prioritized based on the severity and potential impact on the ICS environment.

Automated Response: Depending on the configuration, IoT365 IDS+SIEM can trigger automated response actions, such as isolating affected devices, blocking malicious IP addresses, or escalating to human operators for further investigation.

### 6. Incident Investigation and Reporting

Detailed Logging: All detected events and responses are logged in detail, providing a comprehensive audit trail. This is crucial for post-incident analysis and compliance purposes.

Forensic Analysis: The platform supports forensic analysis by providing tools to dive deep into the detected incidents, helping security teams understand the scope and impact of the discovery attack and plan remediation actions.

By leveraging these capabilities, IoT365 IDS+SIEM ensures robust detection and response to discovery cyber-attacks in ICS environments, aligning with the detailed methodologies outlined in the MITRE ATT&CK framework for ICS. This comprehensive approach helps in mitigating risks and maintaining the integrity and availability of critical industrial operations.

Generally, methodologies can include: 1. Signature-Based Detection that relies on predefined patterns and known indicators of compromise (IOCs) to identify threats. 2. Anomaly-Based Detection that establishes a baseline of normal system behavior and identifies deviations from this norm as potential threats. 3. Behavior-Based Detection that monitors the behavior of users, devices, and applications to detect actions that deviate from normal patterns. 4. Heuristic-Based Detection that uses heuristic algorithms to analyze system activities and identify potentially malicious actions based on heuristic rules. 5. Machine Learning and AI-Based Detection that utilizes machine learning algorithms to analyze vast amounts of data and identify patterns indicative of cyber threats. 6. Threat Intelligence Integration that integrates real-time threat intelligence feeds to enhance the detection capabilities by providing up-to-date information on emerging threats. 7. Network Traffic Analysis (NTA) that monitors and analyzes network traffic to detect suspicious activities and potential intrusions. And 8.

Deep Packet Inspection (DPI) that inspects the data part (and sometimes the header) of packets as they pass through a checkpoint to detect anomalies, intrusions, and malicious activities.

In some examples, the platform includes a unique four (or more)-laver defense technology, which combines various techniques to achieve comprehensive threat detection. In such examples and other embodiments, the platform uses feed detection, utilizing signature-based IP, hash, and URL databases, along with customizable IDS modules. Such an approach enables the identification of known threats and malicious patterns. Furthermore, the integration of machine learning capabilities facilitates pattern recognition, anomaly detection, and continuous learning, empowering the system to detect emerging and zero-day vulnerabilities. The SIEM correlation module employs a simple taxonomy model, allowing for real-time monitoring and the identification of interconnected events.

Additionally, the AI-driven component automates decision-making processes, facilitates contextual understanding, and enables predictive capabilities, significantly enhancing the overall effectiveness of the platform.

In some examples, the platform includes a modular SIEM system specifically designed for the comprehensive analysis and detection of threats and incidents within the aforementioned types of networks. The SIEM system and platform can include several interconnected modules, each serving a distinct purpose in the detection and management of security events. The distributed SIEM platform includes multiple SIEM nodes and a centralized command and control unit. Each SIEM Node encompasses various essential services, including collection, IDS activities, normalization, correlation, classification, and transmission. The command and control module provides ML- and AI-based classification and web access.

In some examples, the collection service gathers raw logs from various sources using different protocols. Once received, the SIEM platform extracts meaningful messages, determined by the service, from the raw data.

The SIEM system can include multiple IDS modules that collectively enhance the threat detection capabilities. The IDS modules encompass a comprehensive approach, combining both feed-based threat detection mechanisms utilizing databases of known malicious URLs, hashes, and IP addresses, as well as manual IDS with preconfigured rules and signatures.

Also, to facilitate effective event management, the SIEM platform can employ a normalization module, which transforms the raw data collected by the collection and IDS modules into standardized events. The normalization module performs calculations, assigns unique identifiers, and enriches the events with relevant contextual information, ensuring consistency and compatibility across the system.

The correlation module can be used to identify relationships among the events and generate meta-events. By aggregating events based on various criteria, such as time intervals and event counts, the correlation module provides a holistic view of a network's security posture. Furthermore, it utilizes the widely recognized MITRE Attack classification to assign meaningful names and descriptions to the meta-events, facilitating a comprehensive understanding of the detected threats.

To further enhance the system's accuracy and reduce false positives, the SIEM platform can incorporate an AI Classification module. Such a module can use advanced artificial intelligence techniques to analyze the meta-events and generate incidents, thereby focusing the attention of security analysts on potential security breaches. By efficiently filtering out false positives, the AI classification module ensures that the incident response efforts are directed towards genuine threats, saving valuable time and resources.

The SIEM platform also includes a transmission module, enabling integration with external systems and tools. This module enables the secure transmission of data generated by the platform to other security platforms, facilitating collaborative analysis and streamlined incident response.

The collected raw logs and events are then directed to a normalization service 106. The normalization service is configured to process and standardize the data, ensuring that it follows a consistent format and structure. It applies specific rules and taxonomies based on the source type, such as workstations, programable logic controllers (PLCs), and switches. The normalization service 106 allows for easier categorization and analysis of the events in subsequent stages.

Next, the normalized data flows to correlation service 107. In the correlation service 107, the events are analyzed and correlated based on predefined correlation rules. These rules consider taxonomy;

time, and other filters to identify patterns, relationships, and potential threats across events. The correlated events are transformed into meta-events, which provide a higher-level view and understanding of the incidents.

The transmission service 108 handles the transfer of messages, events, and meta-events between nodes and command and control. The transmission Service 108 transmits the meta-events to the central transmission service 109 of command and control, as shown by the arrows connecting the service to the command and control component.

The command and control component serves as the central hub for data analysis, decision-making, and management of the SIEM platform. The central transmission service 109 receives meta-events and further processes them, using ML/AI systems 110 and additional security intelligence. The processed data is then transmitted to the central data center 111 for long-term storage and archival purposes.

The web service 112 of command and control provides user interfaces as the central point of interaction for users, allowing them to access and utilize the system's functionalities with case. Users 113, via web browsers, can navigate the web UI to monitor the network, analyze incidents, and generate reports, among other tasks.

Overall, FIG. 1 provides a detailed depiction of the data flow within the SIEM platform, showing the interaction between the collection service, normalization Service, correlation Service, ML/AI module, transmission service, and command and control. This flow ensures efficient data handling, advanced analytics, and effective threat detection and response capabilities.

FIG. 1 also illustrates two example methods of log collection employed by the SIEM platform. The figure also shows the integration of various data sources from the ICS/OT network into the SIEM platform. The first method involves agentless collection through protocols such as Syslog and Windows Event Collector. This allows for the direct retrieval of raw logs from sources such as workstations, PLCs, and switches. The second method utilizes network port mirroring, enabling the SIEM to capture network traffic in its raw format from IoT/ICS/OT devices such as sensors, embedded systems, and security devices. Both approaches ensure that the SIEM receives comprehensive and diverse log data, enabling effective analysis, correlation, and threat detection.

FIG. 1 also shows the log collection process used by the SIEM platform, showcasing its versatility and adaptability to various data sources. The drawing outlines two primary methods utilized for log collection, ensuring comprehensive coverage and accurate analysis within the platform.

The first method depicted in the diagram involves agentless collection through protocols such as syslog and Windows Event Collector. This approach enables the SIEM to directly retrieve raw logs from sources within the ICS/OT network. Supervisory control and data acquisition (SCADA) devices 201, controllers 202, network devices 203, and other devices serve as data sources, generating log information crucial for security analysis and incident response. By using agentless collection 204, the SIEM integrates with these devices, capturing log data without requiring additional software agents or active connections. This method ensures the collection of diverse log information 205, enhancing the depth and breadth of analysis within the SIEM system.

The second method shown in the diagram involves network port mirroring. By configuring switches to mirror network traffic, the SIEM platform can capture and analyze the raw network data transmitted by IoT/ICS/OT devices. Sensors 211, embedded systems 212, and security devices 213 act as data sources, generating valuable network traffic, via a switch 214, that holds insights into potential security threats. The SIEM's ability to collect traffic 215 in its original format provides a comprehensive view of network activities, enabling accurate threat detection and analysis. This method ensures that the SIEM system remains non-intrusive and does not disrupt the operations of IoT/ICS/OT devices, as it passively captures network traffic without directly interacting with the devices themselves.

By employing both agentless collection and network port mirroring, the SIEM platform ensures the collection of diverse and comprehensive log data from various sources within the ICS/OT network.

This approach enables thorough analysis, correlation, and detection of potential threats within the SIEM system. Whether it is the direct retrieval of raw logs from workstations, PLCs, and switches or the capture of network traffic from sensors, embedded systems, and security devices, the SIEM system guarantees the availability of crucial data for effective security monitoring and incident response.

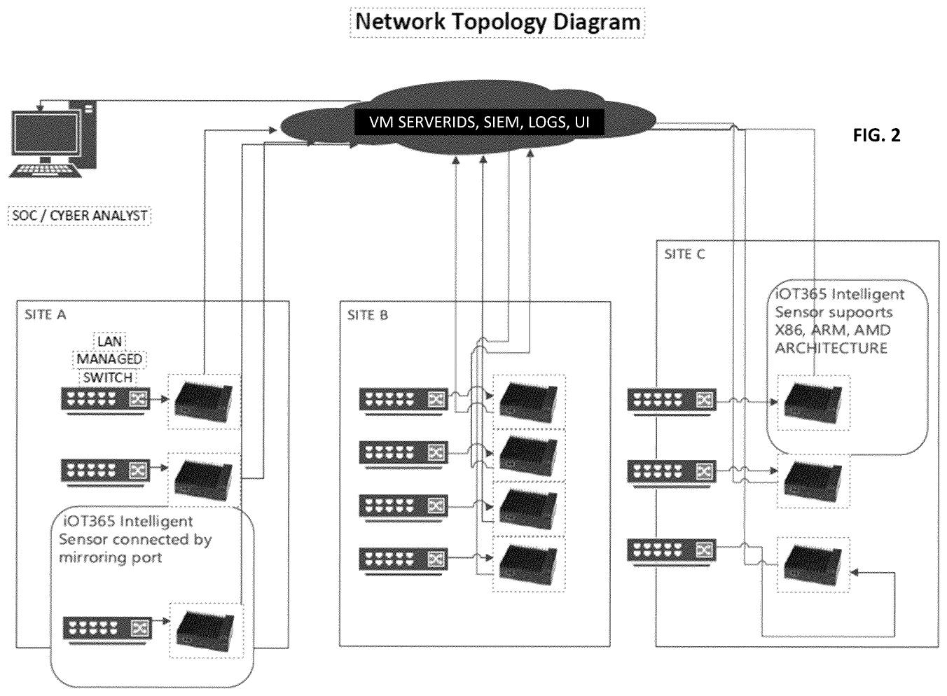

FIG. 2 illustrates a network topology diagram in which physical intelligent sensors are connected to managed switches by mirroring ports in three different sites, according to various embodiments. The sensors gather relevant network data, sort it according to the methods discussed herein, and upload it to the main VM server in the cloud on-premises.

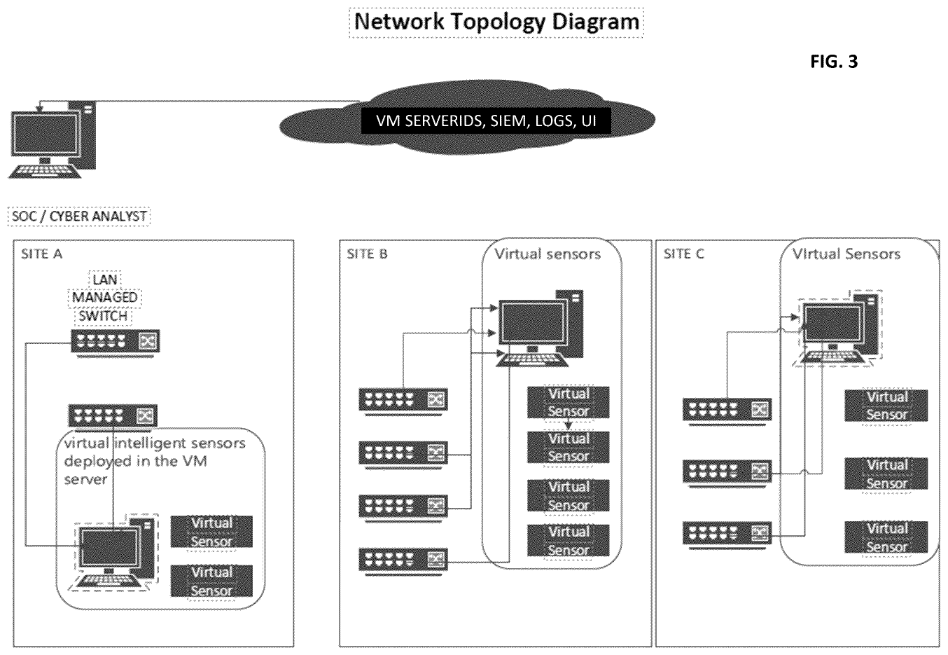

FIG. 3 illustrates a network topology diagram in which virtual Intelligent sensors are connected to managed switches by mirroring ports in three sites, according to various embodiments. The sensors gather relevant network data, sort it according to the methods discussed herein, and upload it to the primary VM server in the cloud on-premises.

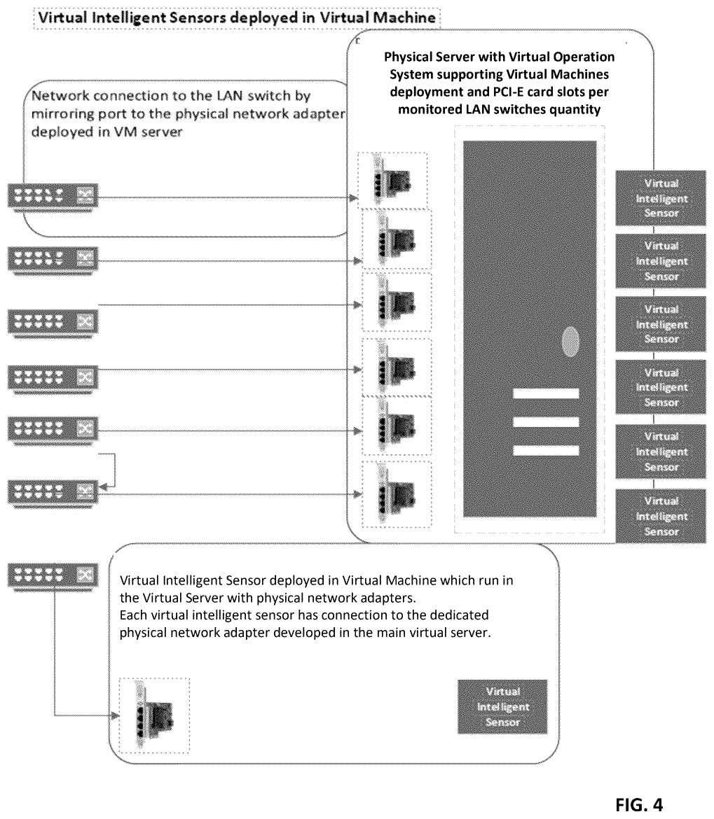

FIG. 4 illustrates the deployment of Virtual Intelligent Sensors in a Virtual Machine, according to various embodiments.

Together FIGS. 2-4 describe a process involves deploying intelligent sensors to capture packet meta events via network mirroring, sorting and enriching the data, securely transmitting it to a central server, and then utilizing the collected data for real-time monitoring and historical analysis. This setup can be deployed either on cloud-based VMs or on-premises, depending on the organization's requirements and preferences. Security and compliance are paramount throughout the process to protect data integrity and privacy.

### Network Topology Diagram

Collecting and sorting packet meta events by utilizing intelligent universal sensors connected to mirroring ports and uploading the data to a main server, either deployed in a cloud-based virtual machine (VM) or on-premises, involves several key steps and components. Here's a detailed explanation of the process:

1. Packet Collection Intelligent Universal Sensors: Deployment: These sensors are strategically deployed across the network to monitor traffic. They are connected to mirroring ports (SPAN ports) or network TAPs (Test Access Points) to receive a copy of the network packets.

Functionality: The sensors are designed to capture packet meta events, which include packet headers and other relevant metadata such as source/destination IP addresses, ports, protocols, timestamps, and possibly payload information if deep packet inspection (DPI) is enabled.

### 2. Data Aggregation and Sorting

Data Collection: Mirroring Ports: SPAN ports are configured on network switches to duplicate network traffic and send it to the sensors without interrupting the original traffic flow.

Data Capture: The sensors continuously capture packet data from these mirrored streams.

Sorting and Processing: Meta Event Extraction: The sensors extract metadata from each captured packet, focusing on key attributes that are essential for analysis.

Data Enrichment: Additional context might be added to the metadata, such as geolocation of IP addresses or tagging packets based on certain criteria (e.g., identifying certain types of traffic like VoIP or HTTP).

### 3. Data Transmission

Uploading Data: Compression and Encryption: Before transmission, the collected data might be compressed to save bandwidth and encrypted to ensure security during transit.

Protocols: Secure protocols (e.g., TLS/SSL) are used for transmitting the data from the sensors to the main server to prevent interception and tampering.

### 4. Data Reception and Storage

Main Server Deployment: Cloud-Based VM: The main server could be a VM hosted on a cloud service provider such as AWS, Azure, or Google Cloud. This allows for scalability and flexibility in resource management.

On-Premises: Alternatively, the main server could be a physical or virtual server located within the organization's own data center, providing more control over data sovereignty and security.

Data Ingestion: Receiver Configuration: The main server is configured to receive data from the sensors. It may use APIs or direct socket connections for this purpose.

Storage Solutions: Collected data is stored in a database or data lake, optimized for handling large volumes of time-series data. Popular solutions include SQL/NoSQL databases or specialized time-series databases such as InfluxDB.

### 5. Data Analysis and Utilization

Real-Time Monitoring: Dashboards and Alerts: The main server can feed the data into monitoring tools that visualize network activity in real-time through dashboards and generate alerts based on predefined rules.

Anomaly Detection: Advanced analytics can be applied to detect unusual patterns indicating potential security threats or network issues.

Historical Analysis: Reporting and Audits: Historical data analysis allows for trend analysis, reporting, and compliance audits.

Machine Learning: Applying machine learning algorithms on historical data can help in predictive analytics and proactive network management.

### 6. Security Considerations

Data Integrity and Privacy: Encryption: Ensure end-to-end encryption of data both in transit and at rest.

Access Control: Implement strict access control measures to limit who can view or manipulate the data.

Compliance: Regulations: Ensure the entire process complies with relevant data protection regulations (e.g., GDPR, HIPAA).

The process involves deploying intelligent sensors to capture packet meta events via network mirroring, sorting and enriching the data, securely transmitting it to a central server, and then utilizing the collected data for real-time monitoring and historical analysis. This setup can be deployed either on cloud-based VMs or on-premises, depending on the organization's requirements and preferences.

Security and compliance are paramount throughout the process to protect data integrity and privacy.

FIG. 5 illustrates intelligent sensor connection method and functionality, according to various embodiment. These methods include Plug-and-play intelligent universal sensors that offer a powerful solution for network monitoring by leveraging mirroring ports and advanced protocol detection. They provide detailed insights through the collection and sorting of packet meta-events, which is crucial for maintaining the security and efficiency of both industrial and IT networks.

### Key Functionalities

Connection to Mirroring Ports: Mirroring Ports: Also known as SPAN (Switched Port Analyzer) ports, these are configured on network switches to duplicate the traffic of specified ports to a designated monitoring port. This allows the sensor to receive a copy of the network traffic without interfering with the original data flow.

Plug-and-Play: The sensors are designed to be easily connected to these mirroring ports. Upon connection, they automatically start receiving and analyzing the mirrored traffic.

Dynamic Detection of Protocols: Industrial Protocols: These include Modbus, DNP3, OPC UA, Profinet, etc., commonly used in industrial control systems (ICS).

TCP/IP Protocols: The foundational protocols for internet and network communication, including HTTP, FTP, SMTP, etc.

Dynamic Detection: The sensors are equipped with software that can automatically identify and classify the different protocols present in the traffic. This is done through deep packet inspection (DPI) and protocol analysis algorithms that recognize protocol signatures and patterns.

Collection of Packet Meta-Events: Meta-Events: These are events that describe the properties of network packets rather than their content. Examples include timestamps, source and destination addresses, port numbers, protocol types, packet sizes, and flow durations.

Data Aggregation: The sensor collects these meta-events from the traffic it monitors. It aggregates this data to provide a comprehensive view of network activity.

Sorting and Analysis: Sorting Meta-Events: The collected meta-events are sorted based on various criteria such as time, protocol type, source/destination addresses, etc. This sorting helps in organizing the data for easier analysis.

Pattern Recognition and Anomaly Detection: The sensor software can analyze the sorted meta-events to identify patterns of normal network behavior. It can also detect anomalies or unusual patterns that may indicate issues such as network intrusions, equipment malfunctions, or protocol violations.

### Detailed Workflow

Connection Phase: The sensor is connected to a mirroring port on a network switch.

It starts receiving a copy of the network traffic immediately due to its plug-and-play nature.

Detection Phase: The sensor dynamically detects the protocols in the incoming traffic using DPI and other techniques.

It identifies the specific industrial and TCP/IP protocols in use.

Collection Phase: As traffic is mirrored, the sensor extracts meta-event data from each packet.

This includes information like timestamps, IP addresses, port numbers, protocol types, packet sizes, etc.

Sorting Phase: The sensor sorts the collected meta-events based on predefined or dynamic criteria.

Sorting can be by time (chronological order), by protocol (grouping similar protocols), by source/destination (to identify specific device communications), etc.

Analysis Phase: The sorted data is analyzed to establish a baseline of normal network behavior.

Advanced algorithms detect deviations from this baseline to identify potential issues.

The analysis results can be used for real-time monitoring, alerts, and historical reporting.

### Benefits

Real-Time Monitoring: Immediate detection and alerting on unusual network activity.

Protocol Awareness: Understanding of both IT (TCP/IP) and OT (industrial) protocols for comprehensive monitoring.

Non-Intrusive: The use of mirroring ports means the sensor does not interfere with actual network traffic.

Automated Configuration: Minimal setup required due to plug-and-play capabilities.

Enhanced Security and Diagnostics: Improved ability to detect and diagnose network problems and security threats.

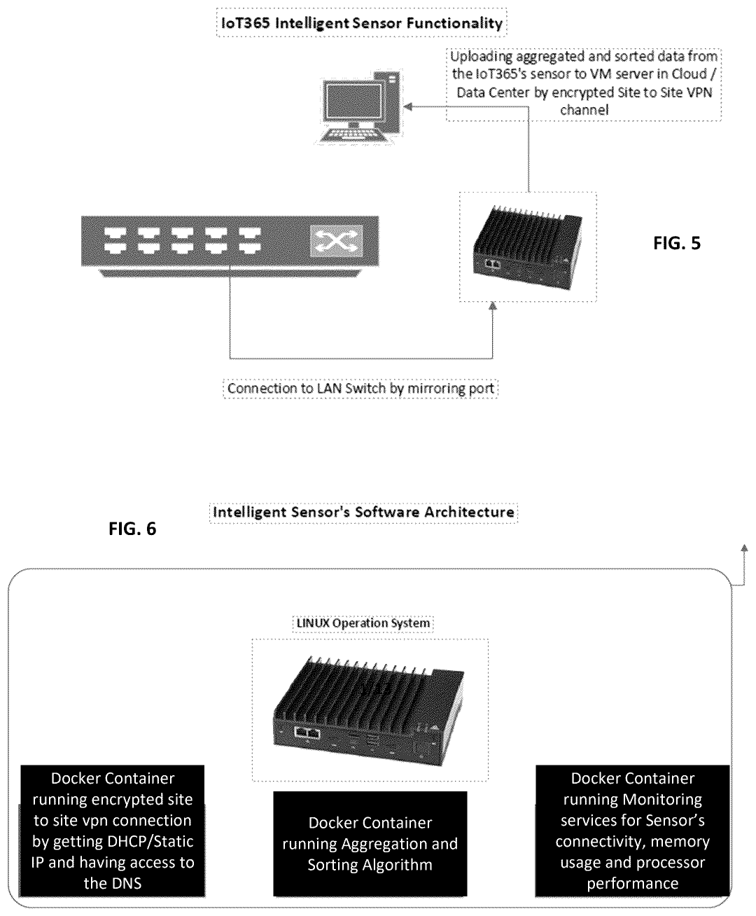

FIG. 6 illustrates an intelligent sensor software architecture, according to various embodiments. This architecture leverages Docker containers to compartmentalize different functionalities of the intelligent sensor software. Each container focuses on a specific task-secure communication, data processing, and monitoring-ensuring a modular, secure, and efficient system. The use of Docker allows for easy updates and scaling, making it a robust solution for network traffic monitoring and analysis.

### Intelligent Sensor Software Architecture

The architecture of the intelligent sensor software leveraging Docker containers for different functionalities provides a modular and efficient way to handle various tasks. Here's a detailed explanation of the architecture:

### Components

Docker Container for VPN Connection

Docker Container for Aggregation, Sorting, and Meta-Event Processing

Docker Container for Monitoring Services

### 1. Docker Container for VPN Connection

Purpose: Establish a secure connection to the main server to ensure secure data transfer and communication.

Functionality: VPN Client: The container runs a VPN client that connects to the main server, creating a secure tunnel.

Authentication: Handles authentication protocols to ensure secure access.

Encryption: Ensures all data transmitted over the VPN is encrypted.

Benefits: Security: Protects sensitive data from interception during transmission.

Remote Management: Allows remote configuration and updates from the main server.

### 2. Docker Container for Aggregation, Sorting, and Meta-Event Processing

Purpose: Handle the core functionalities of data aggregation, sorting, and processing of packet meta-events.

Functionality: Data Collection: Collects meta-events from network traffic (timestamp, source/destination, protocol type, etc.).

Aggregation: Aggregates meta-events to provide a summarized view of network activities.

Sorting: Organizes meta-events based on criteria such as time, protocol type, source/destination addresses.

Processing: Analyzes sorted data for pattern recognition, anomaly detection, and other insights.

Architecture: Input Module: Receives raw meta-event data.

Aggregation Module: Combines meta-event data into meaningful aggregates.

Sorting Module: Sorts data based on defined criteria.

Processing Module: Applies algorithms to detect patterns, anomalies, and generate insights.

### Benefits:

Efficiency: Modular approach allows efficient handling of large volumes of data.

Scalability: Can scale independently based on processing needs.

Flexibility: Algorithms can be updated or changed without affecting other containers.

### 3. Docker Container for Monitoring Services Purpose:

Monitor the performance and health of the sensor's hardware and software components.

Functionality: Processor Monitoring: Tracks CPU usage and performance.

Memory Monitoring: Monitors RAM usage and detects memory leaks.

Traffic Monitoring: Analyzes the amount and type of network traffic handled by the sensor.

Health Checks: Regularly performs health checks on various components to ensure they are functioning correctly.

Logging: Collects logs for troubleshooting and performance analysis.

Alerting: Sends alerts if any performance metrics exceed predefined thresholds.

Architecture: Resource Monitor: Tracks CPU, memory, and disk usage.

Traffic Analyzer: Monitors the volume and types of network traffic.

Health Checker: Regularly checks the health of different services and components.

Logger: Collects and stores logs for analysis.

Alert Manager: Configures alerts for various performance and health metrics.

Benefits: Proactive Maintenance: Allows for early detection and resolution of issues.

Resource Optimization: Ensures optimal use of system resources.

Reliability: Enhances the reliability and uptime of the sensor system.

### Integration of Components

Communication between Containers: Containers communicate via Docker's internal networking capabilities, allowing seamless data exchange between them.

The VPN container ensures secure data transmission to and from the main server, while the aggregation container processes the data, and the monitoring container ensures everything runs smoothly.

Central Management: A central management system on the main server can control and update each container as needed.

This system can push updates, modify configurations, and monitor the health of each container.

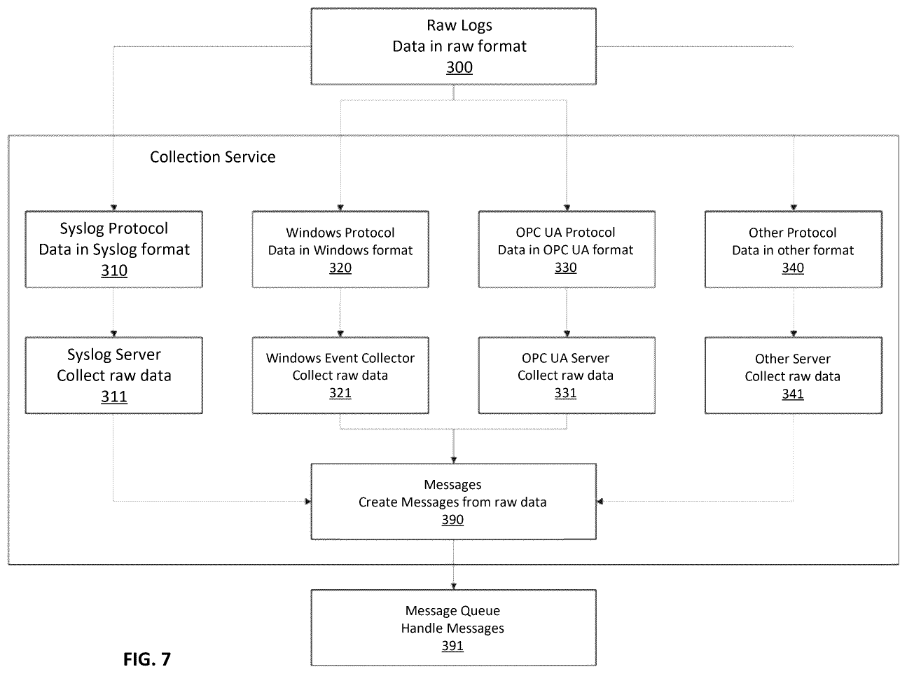

FIG. 7 illustrates an example collection service of the SIEM platform, in accordance with some embodiments of the present disclosure. The collection service is configured to receive and process raw logs from various sources using different protocols such as Syslog, Windows Event Collector, OPC UA, and more. The diagram highlights dedicated servers acting as receivers, accepting data from different sources based on the specified protocols. Once the raw logs are received, the SIEM platform performs data parsing and transformation, extracting meaningful information and converting it into structured messages. The structured messages serve as the basis for further analysis, event normalization, and associations within the SIEM platform. The collection service ensures that the SIEM receives data from diverse sources in a standardized format, facilitating efficient and accurate threat detection and incident response.

FIG. 7 shows the collection service within the SIEM platform, illustrating its role in receiving and processing raw logs 300 from various sources using different protocols. FIG. 7 depicts dedicated servers that serve as receivers, ready to accept incoming data from diverse sources within the network.

These sources utilize protocols such as Syslog 310, Windows Event Collector 320, OPC UA 330, and others 340 to transmit respective raw log information from each of the sources 310, 320, 330, and 340. By using the protocols, the SIEM platform establishes connectivity with the sources, ensuring the smooth retrieval of log data via different servers (e.g., see Syslog server 311, Windows Event Collector 321, OPC UA Server 331, and other servers 341.

Upon receiving the raw logs, the SIEM platform initiates the data processing phase within the collection service. This phase involves data parsing and transformation, where the raw logs are analyzed, and meaningful information is extracted. The collected data is then converted into structured messages 390, which serve as the foundation for subsequent analysis, event normalization, and correlation processes with the platform. Then the collection service sends the messages to message queue 391.

The collection service ensures that the SIEM system receives log data from diverse sources in a standardized and consistent format. By adhering to common protocols and employing dedicated servers for data reception, the SIEM system can effectively.

handle the influx of data from different sources, ensuring its compatibility and readiness for further analysis.

The ability of the collection service to process and transform raw logs into structured messages is vital for the overall functionality of the SIEM system. These Messages provide a standardized representation of log data, enabling efficient analysis, event normalization, and correlation across the SIEM platform. By standardizing the data format, the collection service contributes to the accuracy and effectiveness of threat detection and incident response within the SIEM platform.

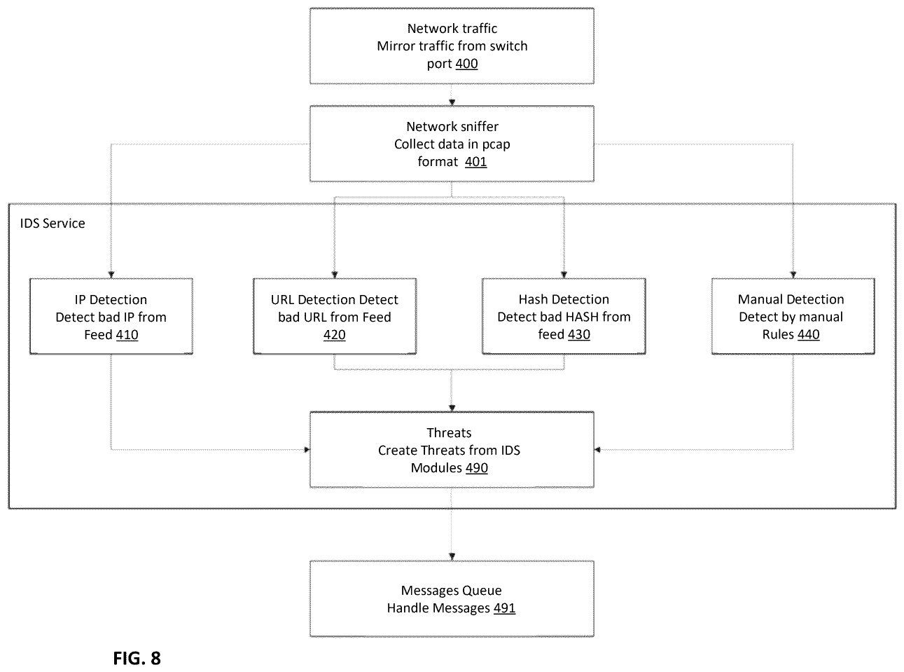

FIG. 8 illustrates an example intrusion detection system (IDS) service of the SIEM platform, in accordance with some embodiments of the present disclosure. The figure depicts the flow of mirror traffic from a switch to a dedicated sniffer, which captures network packets. The captured traffic undergoes analysis by various components, including IP feed detector, URL detector, hash detector, and manual IDS with rule-based detection. Detected threats are sent to the SIEM platform as actionable threats via a message queue. This IDS service enhances the SIEM platform's ability to identify and respond to potential threats in a network, having IoT, ICS, and OT devices that safeguard the network's security and integrity.

FIG. 8 depicts the IDS within the SIEM platform, and it is configured to detect and identify potential threats within the network environment. The figure shows the flow of traffic 400 from the switch, which is mirrored to a dedicated sniffer 401 for analysis. The sniffer captures the network traffic, allowing for detailed inspection and monitoring. The captured traffic then proceeds through various detectors within the IDS service, including the IP feed detector 410, URL detector 420, Hash detector 430, and manual IDS 440 with rules-based detection.

The IP feed detector 410 is configured to identify and analyze IP addresses associated with known malicious activities or sources. It uses threat intelligence feeds and databases to detect suspicious IP addresses within the captured network traffic. The URL detector 420 is configured to scrutinize URLs within the network traffic. It checks for potentially malicious or suspicious URLs that may indicate malicious activity or attempts to exploit vulnerabilities. The Hash detector 430 examines file hashes within the captured traffic. By comparing file hashes against known malicious hashes or signatures, this detector can identify files that may contain malware or other threats.

Additionally, the manual IDS 440, with a rules-based detection component, allows security analysts to define specific rules and criteria for identifying threats within the network traffic. These rules can be customized based on the organization's security policies and requirements.

Once the IDS service detects potential threats within the network traffic, the SIEM platform processes and extracts relevant threat information. The detected threats are then forwarded to the message queue 491, where the threats are organized and stored for further analysis and action.

By incorporating the IDS service into the SIEM platform, organizations can proactively identify and address potential security threats within their networks having IoT, ICS, and OT devices. The combination of automated detection mechanisms and manual rules-based detection empowers security teams to detect a wide range of threats, enhancing the overall security posture of the network environment.

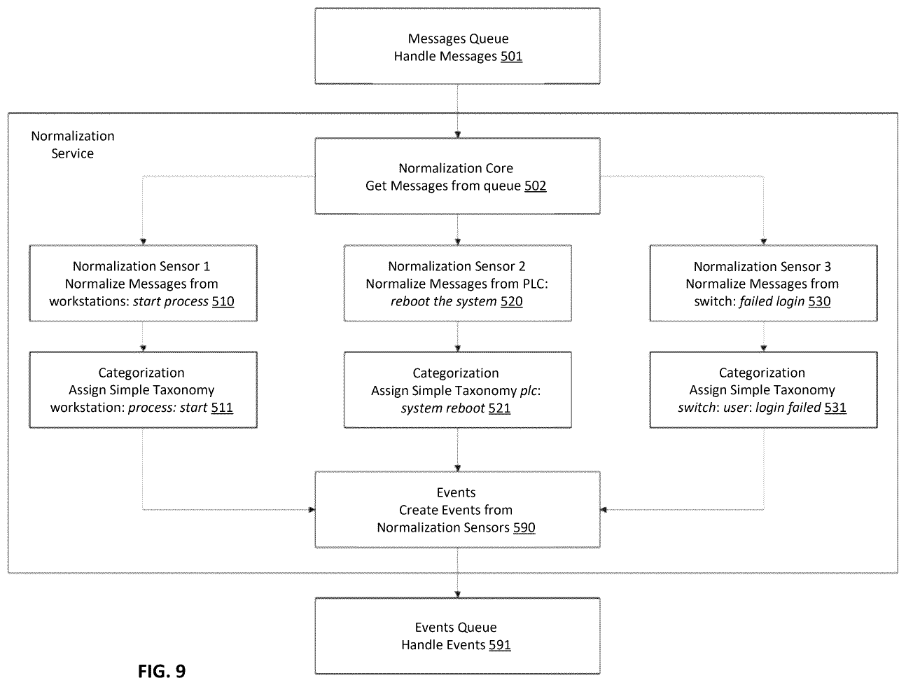

FIG. 9 illustrates an example normalization process of the SIEM platform. The normalization service receives data from the message queue, which contains the collected messages from various sources.

The normalization service then routes the data to specific rules based on the type of source, such as workstation, PLC, or switch. These rules categorize the messages using a simple taxonomy; providing a structured format for further processing. The categorized messages are transformed into events and forwarded to the event queue, ensuring streamlined and organized data for subsequent analysis and correlation. The normalization standardizes the data and prepares it for effective event correlation and threat detection.

FIG. 9 shows the normalization process within the SIEM platform, which is configured to convert raw data into structured events for further analysis and correlation.

This process ensures that the collected data from various sources is organized and standardized, facilitating efficient threat detection and incident response.

The diagram depicts the normalization service, which acts as the central component of the normalization process. The service receives data from message queue 501, via the normalization core 502, which contains the collected messages from sources such as workstations, PLCs, and switches. These messages may contain diverse types of data and information. Upon receiving the data, the normalization core 502 routes it to specific rules based on the type of source. For example, messages originating from workstations, PLCs, or switches are directed to corresponding rules 510, 520, 530 which are designed to handle and categorize data from each specific source.

The rules apply a simple taxonomy model to categorize the messages. This taxonomy model classifies the messages based on their source types, such as identifying whether the message originated from a workstation, a specific PLC, or a switch. By categorizing the messages 511, 521, and 531 the normalization process establishes a structured format that simplifies further processing and analysis. Taxonomy also contains objects and actions, like what or who is an object and what action is made. After normalization event gets the taxonomy: “source: object: action”. For example, if the message contains starting the process on a Windows machine, then the taxonomy will be “workstation: process: start”, for rebooting PLC—“plc: system: reboot”, for failed login to switch—“switch: user: login.failed”. With this categorization, it is easy to handle a large number of messages and generate correlation rules.

Once the messages are categorized, they are transformed into events 590. The events 590 represent significant occurrences or observations within the network environment. The transformed events are then forwarded to event queue 591, where they are stored in an organized manner, ready for subsequent analysis, correlation, and detection of potential threats.

The normalization process is configured to standardize the collected data and prepare the data for effective event correlation. By categorizing the messages and transforming them into events, the SIEM platform can streamline and optimize the subsequent analysis processes, enabling more accurate and efficient threat detection. Overall, the normalization process, depicted in FIG. 9, ensures that the collected data is structured and organized, setting the foundation for effective event correlation and threat detection within the SIEM platform.

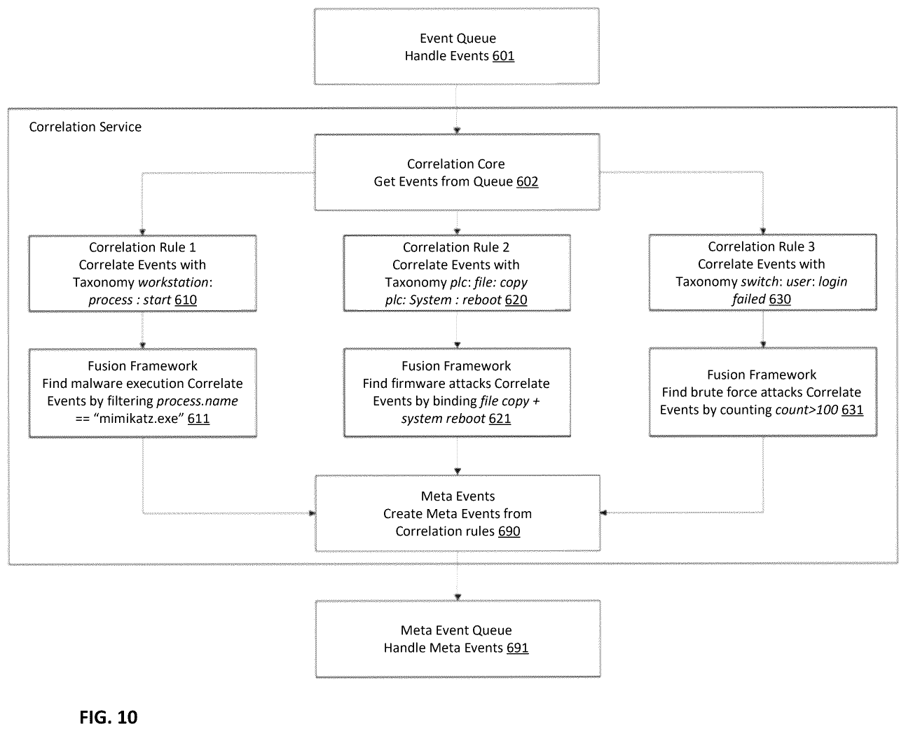

FIG. 10 illustrates an example correlation service of the SIEM platform. The correlation service receives events from the event queue, which contains structured data categorized according to the provided taxonomy; such as workstation: process: start or plc: file: copy. The service applies specific rules for correlation, taking into account filters, time parameters, and the taxonomy itself. Through this process, the correlation service identifies related events, allowing for the generation of meta-events. These meta-events, which encapsulate correlated information, are then directed to the meta-event queue for further analysis and processing. The correlation service is configured to identify meaningful patterns and relationships within the collected events, enabling a comprehensive understanding of potential threats and incidents.

FIG. 10 shows the correlation service in the SIEM platform. The correlation service is configured to analyze and correlate events to identify patterns, relationships, and potential threats within the network environment. The figure illustrates the flow of data and the various components involved in the correlation process. The correlation core 602 receives events from the event queue 601, which contains the structured and categorized events generated during the normalization process. The core 602 then routes the events to specific rules 610, 620, and 630 based on a taxonomy that includes the type of source and the observed action or behavior. The rules applied in the correlation process are designed to detect patterns and relationships among the events using fusion framework parts 611, 621, and 631. The rules may consider factors such time correlation, include or exclude filters, counting and more as event timestamps, event types, source types, or specific actions observed. By applying the rules, the correlation process identifies related events and establishes connections between them, enabling a holistic view of the network activity.

Filters of the correlation service, represented in the diagram, are utilized within the correlation process to refine and narrow down the scope of analysis. These filters may include time-based filters, which focus on events within specific time intervals, or taxonomy-based filters, which concentrate on events of particular types or originating from specific sources. The use of filters allows for targeted analysis and correlation, enhancing the efficiency and accuracy of threat detection.

The correlated events are transformed into meta-events 690, which represent higher-level summaries or aggregated information about related events. These meta-events provide a consolidated view of the activity and highlight potential threats or suspicious patterns that may require further investigation.

Once the meta-events are generated, they are sent to the meta-event queue 691, where they are stored for subsequent processing and analysis. The meta-event queue serves as a repository for consolidated and refined information, ensuring that critical findings are readily available for further actions and decision-making.

The correlation service is configured to identify potential threats and detect anomalous behavior within the network. By analyzing and correlating events, the SIEM platform can uncover hidden patterns, recognize advanced attack techniques, and provide actionable insights for incident response and mitigation.

In summary, FIG. 10 represents the correlation service of the SIEM platform, showing the flow of data and the processes involved in analyzing, correlating, and generating meta-events. This service enhances the SIEM platform's ability to detect and respond to potential threats, enabling organizations to safeguard their networks using IoT, ICS, and OT devices effectively.

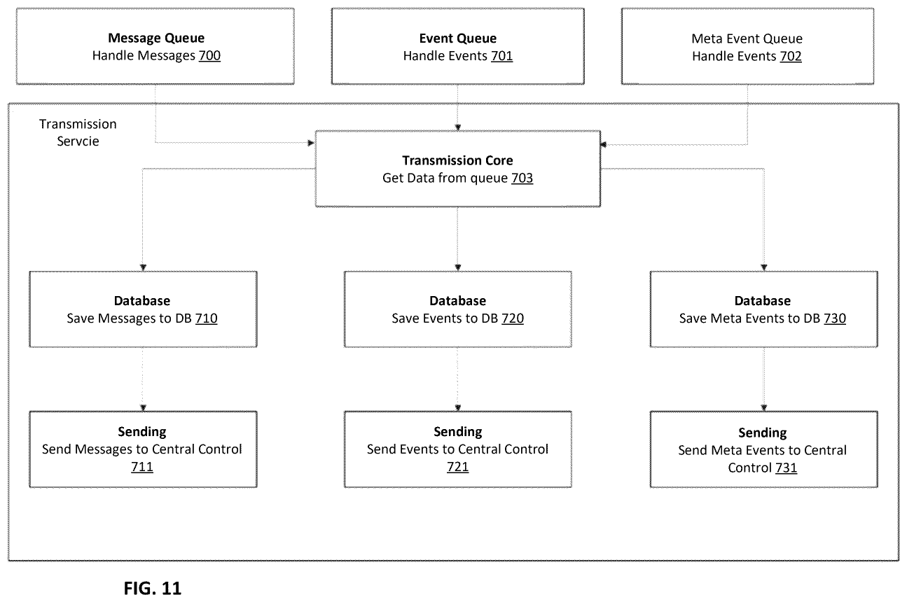

FIG. 11 illustrates an example transmission service of the SIEM platform, in accordance with some embodiments of the present disclosure. The transmission service is configured to manage the data flow from the message queue, event queue, and meta-event queue. It retrieves messages, events, and meta-events from these queues and performs the necessary actions to store them in the database for long-term storage and analysis. The transmission service ensures the transfer of meta-events to the central control, where they can be utilized for centralized monitoring and management. Additionally, depending on the configuration, the service may also transmit events and messages to the central control for further analysis or visibility: This transmission process ensures the efficient and secure handling of the SIEM data, allowing for centralized storage, real-time monitoring, and informed decision making. Also, the transmission service acts as a bridge between the various queues and the central control, facilitating the smooth transfer of data for storage, analysis, and centralized management.

FIG. 11 depicts the data flow from the message queue 700, event queue 701, and meta event queue 702 to the transmission service. The transmission service core 703 retrieves messages, events, and meta-events from these queues and performs operations to ensure their proper handling. One of the primary functions of the transmission service is to save the data 710, 720, and 730 in a database for long-term storage. This enables historical analysis, trend identification, and compliance requirements. By securely storing the SIEM data, organizations can access valuable insights and perform retrospective investigations when necessary.

Additionally, the transmission service is configured to send meta-events to central control 711. Meta-events represent consolidated and refined information derived from the correlation process. These meta-events provide a high-level overview of potential threats, abnormal activities, or significant security events within the IoT/ICS/OT network. By transmitting meta-events to the central control, organizations gain centralized visibility and monitoring capabilities, enabling them to take proactive measures and respond effectively to emerging security incidents. Furthermore, depending on the system configuration, the transmission service may also transmit events 721 and messages 731 to the central control. This allows for real-time monitoring and analysis of security events, providing immediate insights into potential threats and anomalies. By extending the visibility beyond meta-events, the central control can provide a comprehensive view of the network's security posture and facilitate timely incident response.

Overall, FIG. 10 illustrates the role of the transmission service in the SIEM system platform. The transmission service ensures the secure and efficient transmission of data from the queues to the central control and database. By enabling centralized storage, real-time monitoring, and informed decision-making, the transmission service enhances the overall effectiveness and value of the SIEM solution in safeguarding networks having IoT, ICS, and OT devices.

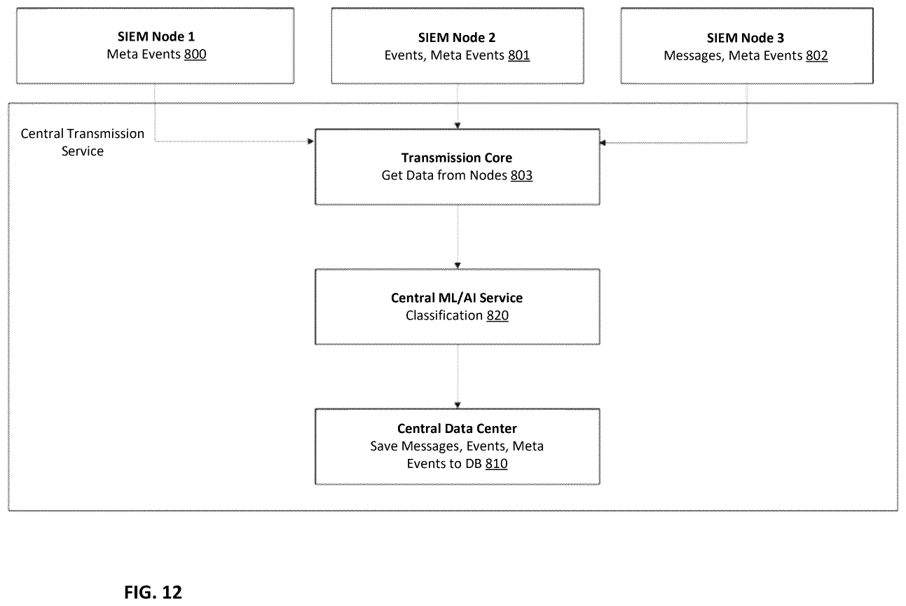

FIG. 12 illustrates an example command and control center of the SIEM platform, in accordance with some embodiments of the present disclosure. Also, known as the central transmission service, the center acts as a hub for receiving messages, events, and meta-events from the transmission service. It serves as a central command center where data is processed and analyzed for advanced threat detection and incident response. The central transmission service forwards the received data to the ML/AI module, where machine learning and artificial intelligence systems are applied to uncover patterns, anomalies, and potential threats. The ML/AI module uses its capabilities to enhance the accuracy and efficiency of threat detection and prediction. Once the analysis is complete, the central SIEM transmits the processed data to the central data center for secure storage and archival. This centralized approach allows for comprehensive data analysis, intelligent decision-making, and a centralized repository of valuable security information for future reference and analysis.

FIG. 12 shows the central transmission service 8, which is configured to be the central control of the SIEM platform. The central control acts as the central processing center of the platform, receiving and processing data from the transmission service and enabling advanced threat detection and response.

At the core 803 of the central control, it is configured to receive messages, events, and meta-events from nodes of the transmission service and the SIEM platform, e.g., see nodes 800, 801, and 802.

These data components contain information about security events, anomalies, and potential threats within the network having IoT, ICS, and OT devices. Once the data is received, the transmission Core 803 directs it to the ML/AI module 820. The module 820 uses machine learning and artificial intelligence systems (such as deep learning and ANNs) to analyze the data and uncover hidden patterns, anomalies, and potential security risks. The ML/AI module's capabilities enhance the SIEM's ability to detect sophisticated and evolving threats, providing organizations with a proactive approach to cybersecurity. After the analysis is complete, the central control transmits the processed data to the central data center 810. This central data center serves as a secure repository for storing and archiving valuable security information. By centralizing the storage of this data, organizations can use it for retrospective analysis, compliance audits, and forensic investigations, thereby bolstering their overall security posture and ensuring regulatory adherence.

The central transmission services act as a centralized hub for data analysis, intelligent decision-making, and information dissemination. It empowers organizations to gain comprehensive insights into their network security; enabling them to take proactive measures and respond effectively to emerging threats. With its advanced capabilities and centralized approach, the central control stands as a critical component in ensuring the resilience and protection of networks and environments having IoT, ICS, and OT devices.

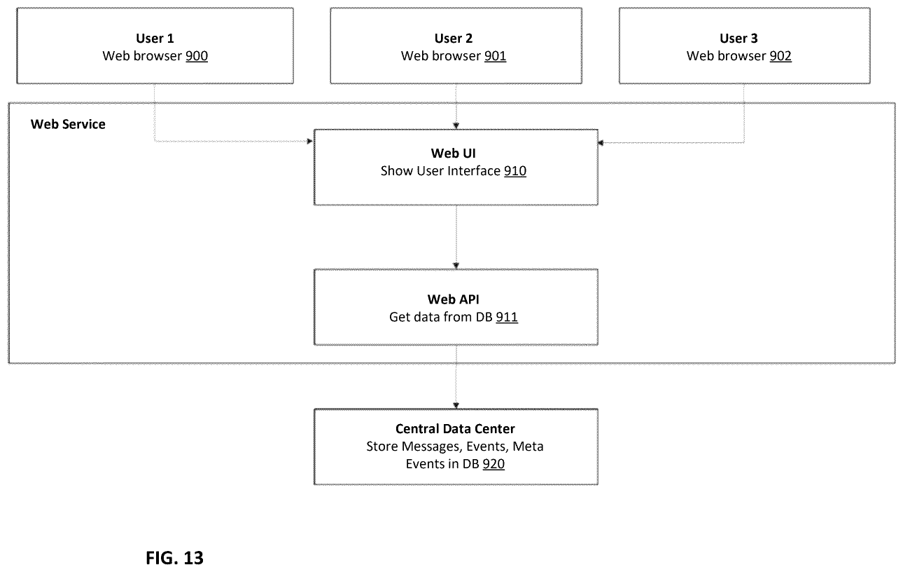

FIG. 13 illustrates an example web service component of the SIEM platform. The web service component provides a web interface that serves as the primary point of interaction for users. Users can access the web user interface (UI) to view and manage the platform's functionalities, such as monitoring the network, analyzing incidents, and generating reports. The web UI communicates with the web API, which acts as an intermediary between the user interface and the central data center. The web API handles user requests and queries, retrieving the necessary data from the central data center for display in the web UI. This communication between the web service components ensures that users can easily access and interact with the SIEM platform and system, providing a convenient and intuitive experience for managing and monitoring the network security of networks having IoT, ICS, and OT devices.

FIG. 13 shows the fundamental web service components within the SIEM platform. The web service component serves as an interface, providing users, e.g., users 900, 901, and 902 with an intuitive way to interact with the SIEM platform. One of the main features of the web service is the web user interface (UI) 910, which users can access to perform various tasks related to network monitoring, incident analysis, and report generation. Through the web UI, users can visualize and manage the system's functionalities, accessing crucial information about the security status of their network having IoT, ICS, and OT devices. To facilitate this interaction, the web UI communicates with the web API 911, which acts as an intermediary between the user interface and the central data center.

When users make requests or queries through the web UI, the web API handles these interactions, retrieving the relevant data from the central data center 920.

The web API plays a role in ensuring the flow of information between the user interface and the underlying SIEM platform. It retrieves the necessary data from the central data center, such as log files, events, and incident reports, and presents it to the users in a format that is accessible and comprehensible.

This interconnectedness between the web UI, web API, and central data center enables users to conveniently monitor and manage the security of their IoT/ICS/OT network. It provides a user-friendly interface that promotes ease of use and accessibility; empowering users to make informed decisions, respond to incidents effectively; and stay updated on the overall security posture of their IoT/ICS/OT environment.

With respect to deployment and integration of the SIEM platform, it can be deployed in both cloud-based and on-premises environments, offering flexibility to organizations based on their specific requirements and security preferences. The deployment process involves installing and configuring the SIEM platform on the designated servers or cloud infrastructure. The platform provides easy-to-follow installation.

instructions and guidelines. Once deployed, the SIEM platform integrates with existing IoT, ICS, and OT networks. It supports various communication protocols commonly used in these environments, allowing for straightforward integration with different types of IoT devices, OT systems, and network infrastructure. The SIEM platform is designed to be vendor-agnostic, ensuring compatibility with a wide range of devices and systems.

With respect to network traffic collection, a first module of the SIEM platform can act as the traffic analysis point (TAP). The first module is configured to passively sniff network traffic from designated mirror ports. In some embodiments, the SIEM platform remains completely disconnected from the production network and minimizes any potential disruption to operations. The TAP filters and captures only the IoT and OT traffic based on specified IP addresses, in some examples. This approach ensures that the SIEM focuses solely on relevant network traffic without interfering with production networks or requiring direct connections to IoT and OT devices.

With respect to data collection and storage, the collected network traffic is forwarded to the main collector component within SIEM platform. The collector receives and stores the raw data in a centralized database. The raw data contains detailed information about network packets, including source and destination IP addresses, protocols, timestamps, and payload. This data serves as the foundation for subsequent analysis and processing.

With respect to threat detection, the SIEM platform uses multiple threat detection mechanisms to identify potential risks and vulnerabilities within IoT and OT networks. The platform uses feed-based detection using signature databases of known malicious IP addresses, hashes, and URLs. It compares the captured network traffic against these databases to identify any matches and flag potential threats.

The first module utilizes pre-defined feeds to detect threats. The second module employs manual IDS techniques, such as Snort, to identify known attack patterns and signatures. The third module utilizes machine learning systems for advanced threat detection, recognizing anomalies, and detecting vulnerabilities (such as zero-day vulnerabilities).

With respect to event normalization and correlation, data collected by the platform and corresponding system is processed by the normalization module of the platform, which converts the raw data into meaningful events. This module applies predefined normalization rules, assigns unique identifiers, and enriches the events with relevant information, such as source device details, event types, severity levels, and timestamps. The correlated events are then processed by the correlation module, which identifies relationships and patterns among events. Using a simple taxonomy model, the SIEM correlates events to form meta-events, aggregating and summarizing related events based on time, count, and other contextual information. The correlation module also applies the MITRE ATT&CK classification framework, providing names and descriptions for detected threats based on recognized attack patterns.

With respect to AI classification and incident generation, the SIEM platform uses AI-driven classification techniques to generate incidents from correlated meta-events. The AI component analyzes the contextual information, applies machine learning systems, and evaluates the severity and likelihood of each incident. This process helps reduce false positives and enables the system to prioritize and escalate incidents based on their potential impact and urgency.

With respect to transmission and integration with external systems, the transmission module within the platform enables the secure and efficient transmission of data to external systems. This integration facilitates the exchange of incident data, threat intelligence, and other relevant information with external security systems, such as Security Orchestration, Automation, and Response (SOAR) platforms. By integrating with SOAR systems, organizations can streamline incident response workflows, automate remediation actions, and enhance overall security operations.

With respect to centralized management and monitoring, the SIEM platform provides a centralized management interface that offers a comprehensive view of the network and system's security posture. The interface includes intuitive dashboards, analytics tools, and customizable reports. Administrators can monitor the state of the network, identify anomalies, track incidents, and view the geolocation of potential attackers. The system or platform stores raw data, events, meta-events, and incidents in a centralized database, enabling efficient searching and retrieval of related information. Administrators can perform advanced searches, apply filters, and extract insights from historical data to aid in forensic investigations and compliance audits.

With respect to customization and configuration, the SIEM platform provides customization and configuration options to adapt to the specific needs of different IoT and OT systems. Administrators can define normalization rules, correlation rules, and system profiles to align the SIEM with the unique characteristics of their environment. This flexibility ensures accurate event representation, effective correlation, and relevant threat detection tailored to the organization's requirements.

With respect to scalability and performance, the platform is designed with a distributed architecture. And it is highly scalable and capable of handling millions of events per second (EPS). The lightweight design optimizes resource utilization, enabling organizations to efficiently manage large-scale IoT and OT deployments without significant infrastructure investments. This approach ensures high performance, rapid event processing, and real-time threat detection without compromising the system's stability.

With respect to exporting and importing capabilities, the platform allows users to export reports, incident data, and configurations in various formats, facilitating data sharing and collaboration with stakeholders. Additionally, the system supports the import and export of configurations, enabling migration between environments or the transfer of configurations across different instances.

With respect to auto-discovery and connectivity monitoring, the SIEM platform features an auto-discovery module that automatically identifies and onboards IoT and OT sources within the network.

This capability eliminates the need for manual configuration and ensures comprehensive coverage of devices and systems. Furthermore, the SIEM platform includes a connectivity monitoring feature that continually monitors the connectivity status and availability of IoT and OT sources. This functionality enables administrators to promptly identify and address connectivity issues, ensuring uninterrupted data collection and threat detection.

In summary; the SIEM platform offers a robust and comprehensive solution for securing IoT and OT networks. Its detailed operations and usage capabilities encompass network traffic collection, threat detection, event normalization and correlation, AI-driven incident generation, centralized management, customization, scalability; and integration with external systems. With its focus on safety; reliability; and productivity; the SIEM platform empowers organizations to proactively safeguard their IoT and OT environments from emerging threats and ensure the continued operation of critical systems.

Additionally, there are some noteworthy alternatives to modules described herein related to the SIEM platform. Such alternatives can replace corresponding modules or can be used with corresponding modules in combination.

Regarding agent-based deployment, while the SIEM platform utilizes an agent-less architecture, an alternative approach could involve deploying lightweight agents on IoT and OT devices. These agents would collect and transmit relevant network traffic data directly to the SIEM system. This approach eliminates the need for mirror port sniffing and enables real-time data collection from individual devices. However, it may require agent deployment and management across a large number of devices, potentially adding complexity to the deployment process.

Also, in addition to the feed-based detection, signature-based IDS, and machine learning techniques employed by the SIEM platform, an alternative approach could incorporate behavior-based threat detection. This method focuses on analyzing the behavior and communication patterns of IoT and OT devices to identify anomalies and potential threats. Behavior-based detection can provide a complementary layer of defense by detecting unknown attacks and abnormal device behavior.

However, implementing behavior-based detection would require extensive device profiling and a deep understanding of normal behavior patterns, which may involve additional configuration and customization efforts.

Regarding hybrid cloud-edge architecture, while the SIEM platform can use both cloud-based and on-premises deployment options, an alternative structure could involve a hybrid cloud-edge architecture.

In this setup, critical processing and analysis tasks could be performed at the network edge, closer to the IoT and OT devices, to ensure real-time threat detection and reduce dependency on cloud connectivity: Edge computing capabilities could be used to process and filter data locally, while key insights and aggregated information are transmitted to the cloud based SIEM for further analysis and correlation. This architecture would enhance real-time monitoring and response capabilities, especially in scenarios where latency or intermittent connectivity to the cloud is a concern.

Regarding enhanced user-defined rules and policies, in addition to the predefined normalization and correlation rules provided by the SIEM platform, an alternative approach could empower users to define and customize their own rules and policies. This flexibility would enable organizations to tailor the SIEM system to their specific IoT and OT environments, incorporating domain-specific knowledge and security requirements. User-defined rules could encompass event filtering, anomaly thresholds, and correlation logic, allowing for fine-tuning and adaptation to evolving threat landscapes. However, implementing user-defined rules and policies would require a user-friendly interface and robust rule validation mechanisms to prevent misconfigurations and false positives.

Regarding collaborative threat intelligence sharing, the SIEM platform could benefit from an alternative process to such sharing. An alternative approach would involve integrating with external threat intelligence platforms and using collective intelligence from industry-specific security communities and organizations. By aggregating and analyzing threat intelligence feeds, the SIEM platform could enhance its threat detection capabilities and proactively identify emerging threats specific to IoT and OT environments. Collaborative threat intelligence sharing can provide broader visibility and ensure organizations stay up to date with the latest threat trends, attack vectors, and mitigation strategics.

The aforesaid alternatives offer different perspectives and options for enhancing the capabilities of the SIEM platform. Each alternative introduces unique considerations and trade-offs, and the selection of the most suitable approach depends on the specific requirements, resources, and risk profile of the organization deploying the SIEM system and platform.

Depending on which embodiment is used, the SIEM platform provides many technical solutions to many technical problems in the field of cybersecurity for networks having IoT, ICS, and OT devices.

One of the example problems solved includes resolving the lack of dedicated focus on IoT/ICS/OT networks. Typical SIEM solutions often lack specialized features and capabilities for monitoring and securing IoT/ICS/OT networks. The SIEM platform addresses this problem by specifically targeting IoT/ICS/OT environments, providing tailored functionalities for detecting threats and incidents in these unique network landscapes. Another one of the example problems solved includes agent collection architecture wherein many SIEM solutions require agents or active connections to devices, which can be challenging to implement in IoT/ICS/OT networks due to device limitations or compatibility issues. The SIEM platform overcomes this problem by employing a passive agent-less architecture. It captures network traffic through mirror ports, applies filtering based on IP addresses to focus on IoT/ICS/OT traffic, and performs analysis without the need for additional software agents. Another example problem solved is the handling of complex event correlation. Typical SIEM systems often rely on complex event correlation models that require extensive rule creation and configuration. The SIEM platform simplifies event correlation by adopting a simple taxonomy model of source type, object, and action. This approach reduces the complexity of rule creation and enhances the speed and efficiency of event correlation. Also, EPS performance is improved by the platform. Another challenge addressed by the SIEM platform is the lack of EPS (Events Per Second) performance in traditional SIEM solutions. IoT/ICS/OT networks generate vast amounts of log data and events, requiring a high-performance SIEM system to handle the volume of incoming data. The SIEM 17 platform is built to handle high EPS rates, ensuring efficient and timely processing of events, rapid threat detection, and effective incident response. Also, specific hardware in various networks can create problems. Typical SIEM solutions often require specific hardware configurations or proprietary appliances, limiting flexibility and scalability. The SIEM platform breaks away from this limitation by being hardware-agnostic also with TAP. It can be deployed on various hardware platforms or virtualized environments, allowing organizations to use their existing infrastructure or choose the hardware that best suits their needs. This flexibility ensures easy deployment, scalability, and the ability to adapt to evolving IoT/ICS/OT network environments without being restricted to specific hardware requirements.

With respect to known SIEM solutions, the SIEM platform has many novel features. For the sake of summarizing such features, in some embodiments, the platform includes a distributed design with nearly unlimited EPS scalability. In such cases, the SIEM platform features a distributed architecture that allows for near-unlimited scalability in handling events per second. The system is designed to efficiently process and analyze high volumes of log data and events generated by IoT and OT networks. By using a distributed design, the SIEM solution can easily scale up or down to accommodate the growing demands of the network without compromising performance. Also, in some embodiments, the SIEM platform operates in an agentless manner, eliminating the need for additional software agents on IoT and OT devices. This agentless approach simplifies deployment and ensures compatibility with a wide range of devices, including those with limited resources or proprietary operating systems. Moreover, the SIEM solution follows the MITRE Attack ICS methodology, specifically tailored for ICS and OT environments. It incorporates industry best practices and knowledge to effectively detect and mitigate threats targeting IoT/ICS/OT networks.

Also, the platform includes a simple taxonomy-based event correlation. The SIEM platform introduces a novel approach to event correlation with its simple taxonomy model of source type, object, and action. This model reduces the complexity associated with traditional event correlation methods, making rule.

creation and customization easier and more efficient. The simplified taxonomy enhances the speed and accuracy of event correlation, enabling real-time threat detection and incident response. Also, in some cases, the platform includes a four-layer defense system using machine learning (ML) and artificial intelligence (AI). The SIEM platform incorporates a robust four-layer defense system, combining rule-based detection, behavioral analysis, anomaly detection, and predictive analytics. This multi-layered approach enhances threat detection accuracy and reduces false positives. By using ML and AI systems, the SIEM solution can analyze vast amounts of data in real time, identifying patterns, anomalies, and potential threats. This empowers security teams with actionable insights and enables proactive incident response. Furthermore, the platform can include a SIEM Node, which is configured to collect logs and capture network traffic, and can be installed on various devices and platforms, providing organizations with flexibility in their deployment options. Whether it's deploying the node on commodity hardware, virtual machines, or using existing infrastructure, the SIEM platform allows organizations to choose the most suitable hardware for their specific needs. This hardware-agnostic approach not only enhances deployment flexibility but also enables scalability and adaptability as IoT/ICS/OT environments evolve. By eliminating the dependency on specific hardware, the SIEM platform empowers organizations to maximize their existing investments while ensuring optimal performance and future-proofing their security infrastructure.

By addressing the lack of specialized focus on IoT/ICS/OT networks, adopting a passive agent-less architecture, and introducing a simple taxonomy-based event correlation approach, the SIEM platform offers novel solutions to technical problems that have previously hindered effective security monitoring and threat detection in IoT/ICS/OT environments.

In addition to the previously mentioned technical problems, the SIEM platform resolves several more challenges commonly encountered in IoT/ICS/OT network security. For example, where there are limited device resources the platform can provide solutions. IoT/ICS/OT devices often have limited computational resources, making it difficult to deploy resource-intensive security solutions. The SIEM platform addresses this problem by utilizing an agent-less architecture that offloads the computational burden to the SIEM infrastructure in the cloud. This approach ensures that the device resources are not overwhelmed, allowing for integration and efficient monitoring without impacting the performance of IoT/ICS/OT devices. Also, for instance, zero-day vulnerabilities can be a problem in such networks. Known security solutions may struggle to detect and respond to zero-day vulnerabilities, which are previously unknown and unpatched vulnerabilities exploited by attackers.

The SIEM platform's layered defense approach (such as its four-layered approach including feed detection, machine learning, SIEM correlation, and AI capabilities) enables it to proactively identify and detect zero-day vulnerabilities. The continuous learning of ML systems combined with threat intelligence feeds and behavioral analysis help in recognizing anomalous patterns and behaviors, providing early detection and response to emerging threats.

Also, the complexity of IoT/ICS/OT Network Architecture can be a major problem. IoT/ICS/OT networks often have complex and heterogeneous architectures with diverse devices, protocols, and communication patterns. The SIEM platform overcomes this challenge by providing a flexible and adaptable solution. Its modular architecture allows for easy integration with various IoT/ICS/OT devices and systems, supporting different protocols and communication interfaces. This adaptability enables the SIEM to fit into the existing IoT/ICS/OT network infrastructure, regardless of its complexity.

Further, such networks can have a lack of centralized visibility: IoT/ICS/OT networks typically have distributed and geographically dispersed devices and systems. This decentralized nature makes it challenging to gain centralized visibility into the security posture of the entire network. The SIEM platform resolves this issue by offering comprehensive central management capabilities. Its intuitive dashboards, analytics tools, and centralized database store enable security administrators to have a holistic view of the network, identify vulnerabilities or anomalies, and respond effectively to security incidents from a centralized location.

Also, the dynamic nature of IoT/ICS/OT environments can be a source of technical issues to resolve. IoT/ICS/OT environments are dynamic, with devices constantly being added, removed, or modified. This dynamic nature poses challenges for security solutions that rely on static configurations. The SIEM platform addresses this challenge by supporting auto-discovery of IoT/ICS/OT sources. It automatically detects and onboards new devices, allowing for integration without the need for manual configuration. This capability ensures that the SIEM stays up to date with the changing IoT/ICS/OT environment and can continuously monitor and protect the evolving network.

By resolving the aforementioned example technical problems, the SIEM platform provides enhanced security capabilities specifically tailored for IoT/ICS/OT networks. It effectively addresses the resource limitations of devices, detects zero-day vulnerabilities, adapts to complex network architectures, provides centralized visibility; and accommodates the dynamic nature of IoT/ICS/OT environments. These solutions enable organizations to mitigate risks, detect threats, and respond effectively to security incidents in their IoT/ICS/OT networks, ultimately ensuring the safety;

reliability; and productivity of their IoT/ICS/OT systems. In addition to resolving technical problems related to IoT/ICS/OT networks, the SIEM platform, in some embodiments, introduces a novel four-layer defense approach to enhance the security posture of these environments. This multi-layered defense strategy provides comprehensive threat detection and incident response capabilities, further distinguishing the SIEM platform from prior solutions. The four layers of defense in the SIEM platform are as follows: feed detection, machine learning layer, SIEM correlation, and an AI layer.

In some examples, the SIEM platform incorporates a feed detection layer that utilizes both signature-based IP, hash, and URL databases, as well as custom IDS (Intrusion Detection System). This layer 8 continuously monitors network traffic and compares it against known threat indicators from various feeds. By using these feeds, the SIEM platform can proactively identify, and alert threats based on known patterns and signatures.

In some examples, the SIEM platform uses an ML layer that can perform advanced systems and methods for pattern recognition, anomaly detection, and continuous learning. It analyzes network behavior, device interactions, and data flows to identify deviations from normal patterns. By continuously learning from the environment, ML systems can detect previously unseen or unknown threats, including zero-day vulnerabilities and sophisticated attacks.

In some examples, the SIEM platform includes SIEM Correlation. The SIEM correlation layer in the SIEM platform performs real-time correlation of events and alerts generated from the collected data.

It applies the simple taxonomy model for event correlation, combining data from multiple sources to identify relationships and potential security incidents. This layer provides a comprehensive view of the security landscape, enabling analysts to detect complex attack scenarios and prioritize response actions.

In some examples, the SIEM platform includes an AI layer. The AI layer of the SIEM platform introduces automated decision-making, contextual understanding, and predictive capabilities. By using AI technologies such as machine learning, natural language processing, and behavioral analysis, this layer enhances the SIEM platform's ability to identify and classify incidents accurately. It reduces false positives, provides contextual insights, and enables proactive threat hunting based on historical data and predictive analytics.

In some embodiments, the integration of the four aforesaid layers of defense in SIEM platform creates a robust and comprehensive security framework. By combining feed detection, machine learning, SIEM correlation, and AI capabilities, the SIEM platform offers enhanced threat detection accuracy, reduced response times, and improved incident management in IoT/ICS/OT environments. This four-layer defense approach sets SIEM platform apart from prior solutions, providing a higher level of security and resilience against evolving cyber threats in the IoT/ICS/OT landscape.

In addition to the previously discussed features, the SIEM platform incorporates several other interesting features that distinguish it from prior technologies in the field for IoT/ICS/OT networks. In some examples, the platform can include geolocation Tracking and network mapping. For instance, the SIEM platform can include geolocation tracking and network mapping capabilities, allowing organizations to track the geographical location of potential attackers or suspicious activities and source statuses within their IoT/ICS/OT networks. This feature enhances situational awareness and enables targeted response measures to be taken, such as blocking traffic from specific regions or implementing additional security controls and vision.

Also, some embodiments can include zero trust framework support. In some instances, the SIEM platform aligns with a zero-trust security framework, which emphasizes continuous authentication, access control, and monitoring of all devices, users, and network traffic. By integrating with the zero-trust model, the SIEM platform provides enhanced security by ensuring that all network entities are constantly evaluated and verified, reducing the risk of unauthorized access and potential breaches.

Also, some embodiments can include customizable normalization rules. The SIEM platform can include customization of normalization rules, which define how raw data is processed and transformed into meaningful events. This feature allows organizations to tailor the SIEM solution to their specific IoT/ICS/OT environment, accommodating unique data formats, protocols, and device behaviors. Customizable normalization rules enhance the accuracy and relevance of generated events, leading to improved threat detection and incident response.

Also, some embodiments can include auto-discovery mechanism that automatically detects and onboards IoT, ICS, and OT sources within the network. This automated process eliminates the need for manual configuration and reduces the administrative burden of adding or removing devices. It ensures that the SIEM solution stays up to date with the evolving IoT/ICS/OT ecosystem, maintaining comprehensive visibility and protection.

These additional features of the SIEM platform contribute to its novelty and provide organizations with advanced functionalities to effectively monitor, analyze, and secure their IoT/ICS/OT networks.

Some portions of the preceding detailed descriptions have been presented in terms of systems and methods and symbolic representations of operations on data bits within a computer memory. These descriptions and representations are the ways used by those skilled in the data processing arts to most effectively convey the substance of their work to others skilled in the art. The operations are those requiring physical manipulations of physical quantities. Usually; though not necessarily; these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The methods and functionality presented herein are not inherently related to any particular computer or other apparatus. Various general-purpose systems can be used with programs in accordance with the teachings herein, or it can prove convenient to construct a more specialized apparatus to perform the methods described herein. The structure for a variety of these systems will appear as set forth herein. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly; to be regarded in an illustrative sense rather than a restrictive sense.

AI-Generated Playbooks: Based on the analysis conducted by the SIEM deployment, the platform generates AI-generated playbooks tailored to specific industry standards and regulations, such as NIS2, NIS2, NIST, IEC-62443, ABP (Anomalies Behaviour Profiling), DPI (deep packets inspection), ISA/IEC 62443, and/or any combination thereof. It is anticipated that s new playbooks are developed these may be incorporated into the disclosed SIEM system. These playbooks outline predefined response procedures for addressing detected threats and ensuring compliance with relevant standards.

Real-Time Threat Response: The platform enables organizations to respond to security incidents in real-time by following the instructions outlined in the AI-generated playbooks. This proactive approach helps minimize the impact of security breaches and mitigate risks effectively.

Each illustrated component of the computer network 10 can include a computer system having an operating system, a microprocessor, a display; communication circuits, and/or storage media. The media can include volatile memory components, non-volatile memory components, or a combination of such. In general, each of the computer systems can include a host system that uses the memory. For example, the host system can write data to the memory and read data from the memory. The host system can be a computing device such as a desktop computer, laptop computer, network server, mobile device, or such computing device that includes a memory and a processing device. The host system can include or be coupled to the memory so that the host system can read data from or write data to the memory: The host system can be coupled to the memory via a physical host interface. The physical host interface can provide an interface for passing control, address, data, and other signals between the memory and the host system.

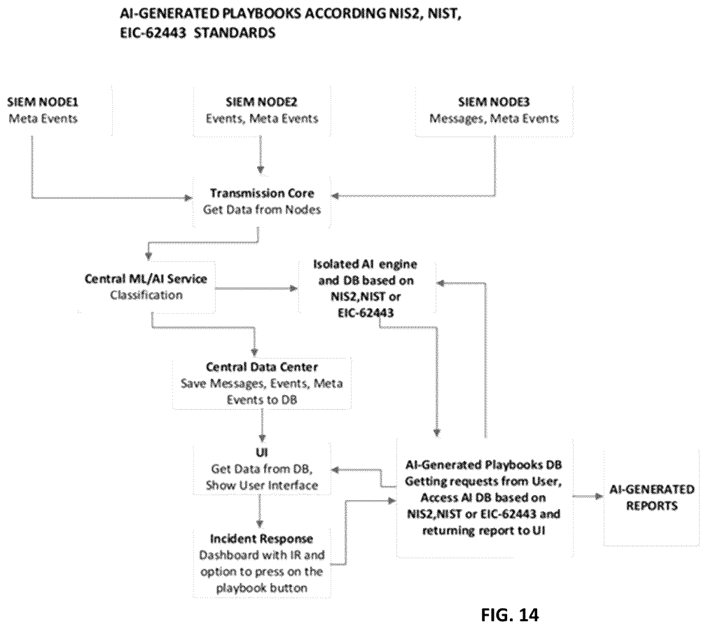

FIG. 14 illustrates AI-generated Playbooks workflow according to NIS2, NIST, or IEC-62443 Standard, in accordance with various embodiments. AI-generated playbooks for OT cybersecurity incidents are transformative tools that enhance the speed, efficiency, and effectiveness of incident response. By leveraging internal databases, complying with key standards, and focusing on providing clear and relevant information, these playbooks significantly reduce response times and improve overall cybersecurity resilience.

### Game-Changing Aspects of AI-Generated Playbooks

Automated Generation and Customization: Dynamic Playbook Creation: AI systems can automatically generate incident response playbooks tailored to specific threats and environments.

These playbooks are continuously updated based on evolving threat intelligence and past incident data.

Customization: Playbooks are customized based on the organization's infrastructure, current security posture, and regulatory requirements.

Integration with Internal Databases: Knowledge Base: Leveraging internal databases containing historical incident data, asset information, and vulnerability details, AI can generate highly relevant and context-aware playbooks.

Threat Intelligence: Integration with threat intelligence feeds ensures the playbooks include the latest information on threat actors, tactics, techniques, and procedures (TTPs).

Standards Compliance: Alignment with Standards: AI-generated playbooks are designed to comply with NIS2, NIST, and IEC-62443 standards, ensuring that they meet regulatory requirements and industry best practices.

Auditable Processes: These playbooks include documentation and evidence of compliance, facilitating audits and regulatory reviews.

Focused and Clear Information: Concise Guidance: Playbooks provide clear and concise steps for responding to incidents, tailored to the roles and responsibilities of relevant personnel.

Role-Based Access: Information is prioritized and filtered based on the role of the responder, ensuring that each team member receives only the most pertinent instructions.

Reduction in Response Time: Rapid Decision-Making: By providing precise and actionable information, AI-generated playbooks enable quicker decision-making and faster incident resolution.

Automated Actions: Certain responses can be automated, such as isolating affected systems or blocking malicious IP addresses, further reducing the manual effort required.

Continuous Improvement: Feedback Loop: AI systems learn from each incident, improving the accuracy and effectiveness of future playbooks.

Post-Incident Analysis: Detailed analysis of incidents and response effectiveness is used to refine and update playbooks.

### Workflow of AI-Generated Playbooks

Threat Detection: Real-Time Monitoring: Continuous monitoring of network and system activity using advanced analytics and machine learning.

Anomaly Detection: Identification of unusual patterns that may indicate a cybersecurity incident.

Playbook Generation: Contextual Analysis: AI analyzes the detected threat in the context of the organization's specific environment and past incidents.

Standard Compliance Check: Ensures the generated playbook aligns with NIS2, NIST, and IEC-standards.

Custom Instructions: Provides detailed and role-specific instructions for mitigating the threat.

Incident Response: Alerting and Notification: Relevant personnel are alerted with the AI-generated playbook.

Execution of Actions: Teams follow the playbook, executing predefined steps to contain and mitigate the threat.

Automated Response: Certain actions are automatically executed by the system to speed up response times.

Post-Incident Review: Incident Analysis: AI analyzes the incident and the effectiveness of the response.

Playbook Refinement: Updates the internal databases and refines future playbooks based on lessons learned.

### Benefits for Relevant Personnel

Efficiency: Reduces the time required to generate and execute incident response plans.

Streamlines the decision-making process during high-pressure situations.

Effectiveness: Enhances the precision and relevance of incident response actions.

Ensures compliance with critical cybersecurity standards and regulations.

Clarity: Provides clear and unambiguous instructions tailored to each role, reducing the likelihood of errors.

Improves communication and coordination among response teams.

Proactive Security Posture: Continuously updates and improves incident response capabilities.

Prepares the organization for emerging threats and evolving attack vectors.

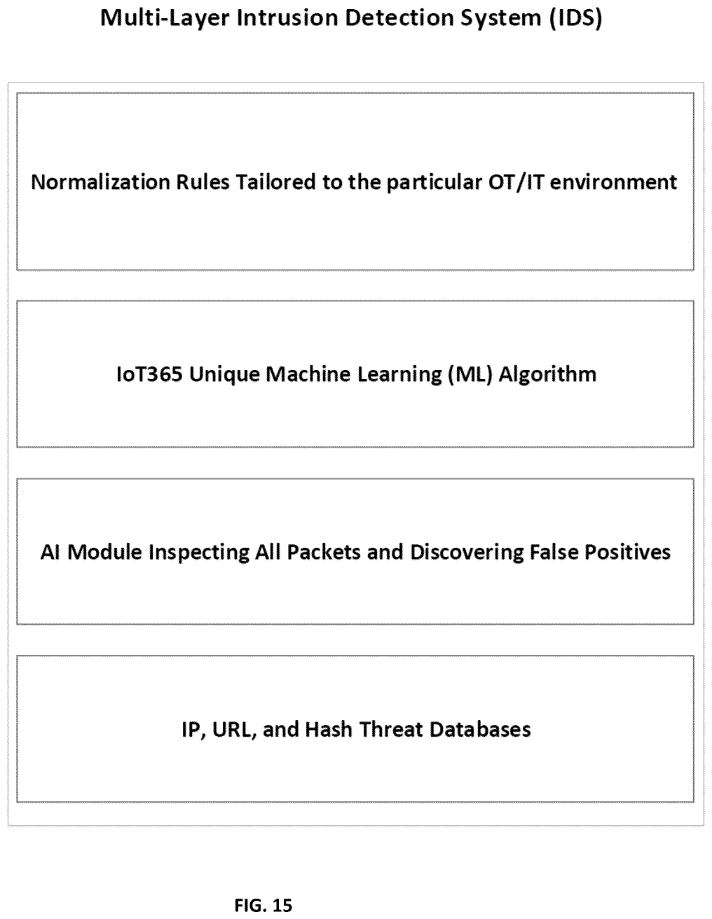

FIG. 15 illustrates features of a Multi-Layer Intrusion Detection System (IDS), according to various embodiments. A multi-layer intrusion detection system enhances an organization's security by employing multiple layers of defense, each designed to address different aspects of potential threats.

Here's a detailed breakdown of the four layers you mentioned:

### 1. First Layer: Normalization Rules Tailored to the Particular OT/IT Environment

**Purpose**: This layer is designed to handle an organization's unique operational technology (OT) and information technology (IT) environments. It focuses on normalizing data, which means standardizing and cleansing data from various sources to make it consistent and easier to analyze.
**Normalization Rules**: These rules are specific to the organization's environment and are used to filter out known benign activities, reduce noise, and highlight potential anomalies. By tailoring these rules, the system can more effectively identify unusual patterns or behaviors that may indicate a threat.

### 2. Second Layer: IoT365 Unique Machine Learning (ML) Algorithm

**Purpose**: The second layer leverages machine learning algorithms to detect sophisticated and previously unknown threats.
**IoT365 ML Algorithm**: This proprietary algorithm is designed to analyze large volumes of data, learn from historical attack patterns, and identify potential threats in real-time. It continuously improves its detection capabilities by learning from new data, making it effective against evolving threats.

### 3. Third Layer: AI Module Inspecting All Packets and Discovering False Positives

**Purpose**: This layer aims to enhance the accuracy of threat detection by reducing false positives, which are benign activities mistakenly identified as threats.
**AI Module**: An advanced AI system inspects all network packets, looking for signs of malicious activity. It uses sophisticated techniques to differentiate between legitimate traffic and potential threats. By identifying and eliminating false positives, this layer ensures that security teams can focus on genuine threats, improving overall efficiency.

### 4. Additional Layer: IP, URL, and Hash Threat Databases

**Purpose**: This layer provides an additional line of defense by comparing detected threats with known malicious entities.
**Threat Databases**: These databases contain information on known malicious IP addresses, URLs, and file hashes compiled by leading cybersecurity organizations. When the system detects suspicious activity, it checks this information against the threat databases to quickly identify and confirm known threats. This cross-referencing helps in taking immediate action against confirmed threats and improves the system's overall threat intelligence.

The above layers may be applied in any order.

### Summary of Layers

This multi-layer IDS structure offers a robust defense mechanism by combining tailored normalization rules, advanced machine learning, AI-driven packet inspection, and comprehensive threat intelligence databases. Each layer complements the others, providing a comprehensive approach to threat detection and mitigation:
1. **Normalization Rules**: Tailored filtering to reduce noise and highlight anomalies.
2. **ML Algorithm**: Identifies sophisticated threats by learning from data.
3. **AI Module**: Inspects traffic and reduces false positives, focusing on real threats.
4. **Threat Databases**: Confirms known threats by comparing with extensive cybersecurity databases.

By integrating these layers, organizations can effectively protect their IT and OT environments from a wide range of cyber threats.

The computing systems discussed herein can correspond to a host system that includes, is coupled to, or utilizes memory or can be used to perform the operations of a controller (e.g., to execute an operating system to perform operations corresponding to any one of the client or server devices discussed herein). In alternative embodiments, the machine can be connected (e.g., networked) to other machines in a LAN, an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

Typically, the computing system includes a processing device, a main memory (e.g., read-only memory (ROM), flash memory; dynamic random-access memory (DRAM), etc.), a static memory (e.g., flash memory; static random-access memory (SRAM), etc.), and a data storage system, which communicate with each other via a bus.

The processing device represents one or more general-purpose processing devices such as a microprocessor, a central processing unit, or the like. More particularly; the processing device can be a microprocessor or a processor implementing other instruction sets, or processors implementing a combination of instruction sets. The processing device can also be one or more special-purpose processing devices such as an application specific integrated circuit (ASIC), a field programmable gate array (FPGA), a digital signal processor (DSP), a network processor, or the like. The processing device is configured to execute instructions for performing the operations discussed herein. The computing system 20 can further include a network interface device 28 to communicate over the LAN/WAN network(s).

The data storage system can include a machine-readable storage medium (also known as a non-transient computer-readable medium) on which is stored one or more sets of instructions 34 or software embodying any one or more of the methodologies or functions described herein. The instructions can also reside, completely or at least partially, within the main memory and/or within the processing device during execution thereof by the computing system, the main memory 24, and the processing device also constituting machine-readable storage media.

In one embodiment, the instructions include instructions to implement functionality corresponding to the client devices and server devices shown in FIG. 1 (While the machine-readable storage medium is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure.

The term “machine-readable storage medium” shall accordingly be taken to include, but not be limited to, solid-state memories, optical media, and magnetic media.

The “logic” discussed herein is explicitly defined to include hardware, firmware or software stored on a non-transient computer readable medium, or any combinations thereof. This logic may be implemented in a quantum, electronic and/or digital device (e.g., a circuit) to produce a special purpose computing system. Any of the systems discussed herein optionally include a microprocessor, including quantum, electronic and/or optical circuits, configured to execute any combination of the logic discussed herein. The methods discussed herein optionally include execution of the logic by said microprocessor.

What is claimed is:

1. A security information and event management system comprising:
an input configured to receive and store logs of traffic sensor data from a plurality of sources, the sources including at least one agentless source and including mirrored network traffic, the traffic sensor data being communicated using a plurality of protocols;
an optional input configured to receive events from a security agent:
normalization logic configured to normalize the traffic sensor data communicated using the plurality of protocols to a normalized (generic and protocol independent) representation;
correlation logic configured to produce correlation data based on correlation between the normalized representation of the traffic sensor data and a plurality of attack methodologies; and
a machine learning system trained using the correlation data, and configured to detect security events based on the normalized traffic sensor data.

2. The system of claim 1, wherein the normalization logic and/or correlation logic are disposed on a hardware device configured to be connected to a network switch, wherein the hardware device is optionally configured to communicate to a security server using an encrypted VPN.

3. The system of claim 1, wherein the normalization logic is disposed in a virtual device configured to physical network adapter connected to a virtual machine server, wherein the virtual device is optionally configured to communicate to a security server using an encrypted VPN.

4. The system of claim 1, further comprising AI training logic configured to train the machine learning system using the correlation data.

5. The system of claim 1, further comprising a plurality of physical condition sensors.

6. The system of claim 5, wherein the physical condition sensors include a temperature sensor, a pressure sensor, a camera, and/or an access control device.

7. The system claim 1, wherein the plurality of attack methodologies include at least 2 or more of MITRE Attack ICS methodology, NIS2, NIST, and IEC 62443 methodologies.

8. The system of claim 1, wherein the normalization logic is disposed at least in part in a traffic sensor that generates the traffic sensor data.

9. The system of claim 1, wherein the traffic sensor data include data communicated to or from a programmable logic controller, OT, human machine interface, SCADA, or other IoT device, e.g., data written to or read from these devices.

10. The system of claim 1, wherein the traffic sensor data is generated by a single traffic sensor connected to a plurality of physical network switches, the single traffic sensor including multiple Ethernet monitoring ports.
